(19) United States
(12) Patent Application Publication
(10) Pub. No.: US 2024/0061428 A1
(43) Pub. Date: Feb. 22, 2024

(54) SYSTEMS AND METHODS OF GUARDING A MOBILE ROBOT

(71) Applicant: Boston Dynamics, Inc., Waltham, MA (US)

(72) Inventors: Alexander Perkins, Lincoln, MA (US); Michael Murphy, Carlisle, MA (US); Guillermo Diaz-Lankenau, Santa Clara, CA (US); Federico Vicentini, Lexington, MA (US); Mark Nehrkorn, Oregon, IL (US)

(73) Assignee: Boston Dynamics, Inc., Waltham, MA (US)

(21) Appl. No.: 18/447,518

(22) Filed: Aug. 10, 2023

Related U.S. Application Data
(60) Provisional application No. 63/398,907, filed on Aug. 18, 2022.
(60) Provisional application No. 63/451,055, filed on Mar. 9, 2023.

(51) Int. Cl. G05D 1/02; B25J 5/00; B66F 9/06

(52) U.S. Cl. CPC G05D 1/021; B25J 5/007; B66F 9/063; G05D 2201/0216

(57) ABSTRACT

A computing device receives location information for a mobile robot. The computing device also receives location information for an entity in an environment of the mobile robot. The computing device determines a distance between the mobile robot and the entity in the environment of the mobile robot. The computing device determines one or more operating parameters for the mobile robot. The one or more operating parameters are based on the determined distance.

### RELATED APPLICATIONS

This application claims the benefit under 35 U.S.C. § 119(e) of U.S. Provisional Patent Application Ser. No. 63/398,907, filed Aug. 18, 2022, and entitled “SYSTEMS AND METHODS OF GUARDING A MOBILE ROBOT,” and to U.S. Provisional Patent Application Ser. No. 63/451,055, filed Mar. 9, 2023, and entitled “SYSTEMS AND METHODS OF GUARDING A MOBILE ROBOT,” the entire contents of each of which is incorporated herein by reference.

### TECHNICAL FIELD

This application relates generally to robotics and more specifically to systems, methods and apparatuses, including computer programs, for determining safety and/or operating parameters for robotic devices.

### BACKGROUND

A robot is generally defined as a reprogrammable and multifunctional manipulator designed to move material, parts, tools, and/or specialized devices (e.g., via variable programmed motions) for performing tasks. Robots may include manipulators that are physically anchored (e.g., industrial robotic arms), mobile devices that move throughout an environment (e.g., using legs, wheels, or traction-based mechanisms), or some combination of one or more manipulators and one or more mobile devices. Robots are currently used in a variety of industries, including, for example, manufacturing, warehouse logistics, transportation, hazardous environments, exploration, and healthcare.

### SUMMARY

During operation, mobile robots can be hazardous to entities in the environment (e.g., humans or other robots). For example, mobile manipulator robots that are large and powerful enough to move packages from one location to another at high speeds can be dangerous to operators or other workers nearby. In such settings, mobile robots should have systems that protect entities of concern in the environment, e.g., by making sure that they are not dangerously close to the entities while operating at high speeds.

In some situations, physical guarding systems can help serve this need. One such system includes a cage comprised of one or more panels, which can surround the robot during operation and/or be configured to move with the robot (e.g., from one bay to another in a warehouse). Cage systems can prevent entities of concern from entering and/or a robot from leaving the robot's work zone. Another system includes one or more curtains that can be used to define boundaries of the work zone and/or shut down a robot if entities of concern breach the boundaries. However, physical guarding systems can suffer from multiple drawbacks, including but not limited to (i) taking up significant valuable space in the warehouse; (ii) interfering with operations in the warehouse, particularly in activity-dense environments (e.g., loading docks); and/or (iii) making it difficult to move and/or reconfigure boundaries (e.g., in shared spaces). For at least these reasons, a solution with lower infrastructure requirements (e.g., due to cost of acquisition, operation, and/or maintenance) and/or a solution that is more customizable is preferable.

Some embodiments include systems, methods and/or apparatuses, including computer programs, for receiving location information for a robot and/or one or more entities of concern (e.g., people or other robots) in the environment of the robot (e.g., in or near the robot's work zone). Based on this information, a distance can be calculated (e.g., a minimum allowable distance between the robot and one or more of the entities of concern, such as the closest entity to the robot or a somewhat further but faster approaching entity), and that distance can help determine one or more thresholds or ranges of permitted operating parameters of the robot at a given time (e.g., the fastest allowable safe operating speed for an arm and/or the fastest allowable safe travel speed of a base of the robot at a particular time or interval). One or more operations of the robot can then be constrained according to these thresholds or ranges of permitted operating parameters to facilitate safe operation of the robot in particular environment scenarios.

Using such systems and/or methods, the robot can be enabled to maximize its operating efficiency in a given situation subject to the safety constraints that the situation presents. For example, the robot can be allowed to operate at one or more full (e.g., maximum) speeds when people are sufficiently far from the robot, but may be required to operate at one or more lower speeds (e.g., one or more maximum safe speeds) when people are closer to the robot. As another example, if an adjacent loading dock is occupied by one or more people, a robot can continue to operate at limited speed, but as the robot moves into a truck and/or as the one or more people leave the vicinity of the robot, its speed can safely increase. In this way, the maximum speed at which the robot is allowed to operate can be modulated as entities of concern (and/or the robot) move within the environment.

Such systems and methods can lead to lower-cost and faster setup routines than systems that rely solely on physical guarding techniques. In some embodiments, the system includes fewer components that may fail over time. In some embodiments, fewer physical touch points exist within the system. In some embodiments, the system has less physical equipment to move (e.g., from bay to bay), reducing the amount of labor-intensive work and/or time required to transition the robot to the next task or area. In some embodiments, if a robot working within a truck container moves further into the container over time, the area monitored for entities may shrink accordingly, allowing entities to move more freely throughout the environment by virtue of being outside of the robot's monitored area. Some or all of these advantages can lead to greater productivity during operation of the robot.

In one aspect, the invention features a method. The method includes receiving, by a computing device, first location information for a mobile robot. The method includes receiving, by the computing device, second location information for a first entity in an environment of the mobile robot. The method includes determining, by the computing device, based, at least in part, on the first location information and the second location information, a first distance between the mobile robot and the first entity in the environment of the mobile robot. The method includes determining, by the computing device, one or more operating parameters for the mobile robot. The one or more operating parameters can be based on the first distance.

In some embodiments, receiving first location information for the mobile robot comprises receiving sensor data indicating a location of the mobile robot. In some embodiments, receiving second location information for the first entity comprises receiving an indication that the first entity is located in a region defining a safety zone of the mobile robot. In some embodiments, the computing device is included in the mobile robot. In some embodiments, the computing device is included in a zone controller in communication with the mobile robot. In some embodiments, the method further comprises communicating, by the computing device, the one or more operating parameters to the mobile robot. In some embodiments, the method further comprises controlling, by the computing device, the mobile robot to move according to the one or more operating parameters.

In some embodiments, the one or more operating parameters comprise an operating speed limit. In some embodiments, the operating speed limit comprises a travel speed limit of a base of the mobile robot. In some embodiments, the operating speed limit comprises a speed limit of a point in space. The point in space can be located on an exterior surface of a robotic arm, a robotic manipulator, a robotic joint of the mobile robot, or an object manipulated by the mobile robot. In some embodiments, the one or more operating parameters comprise a stopping time limit. In some embodiments, the one or more operating parameters comprise an operating acceleration limit. In some embodiments, the method further comprises setting, by the computing device, the operating speed limit at a maximum operating speed limit when the computing device determines that the first entity is beyond a threshold distance from the mobile robot. In some embodiments, the method further comprises setting, by the computing device, the operating speed limit at a speed limit that is lower than a maximum operating speed limit when the computing device determines that the first entity is less than a threshold distance from the mobile robot. In some embodiments, the method further comprises adjusting, by the computing device, the operating speed limit when the computing device determines that the first entity has moved into or out of a safety zone.

In some embodiments, the first entity is determined, based on sensed data, to have a linear dimension of at least 70 mm in a plane located at least 100 mm above a ground plane. In some embodiments, the method further comprises receiving, by the computing device, a signal indicating that the first entity comprises an entity of concern. In some embodiments, the method further comprises receiving, by the computing device, a velocity of the first entity, wherein the one or more operating parameters are based on the velocity of the first entity. In some embodiments, the method further comprises receiving, by the computing device, an acceleration of the first entity, wherein the one or more operating parameters are based on the acceleration of the first entity. In some embodiments, the method further comprises determining, by the computing device, an operating acceleration limit of the mobile robot. The operating acceleration limit can be included in the one or more operating parameters for the mobile robot. In some embodiments, the method further comprises receiving, by the computing device, third location information for a second entity in the environment of the mobile robot, and determining, by the computing device, based on the third location information, a second distance between the mobile robot and the second entity. The one or more operating parameters can be based on a smaller distance of the first distance and the second distance.

In some embodiments, the method further comprises receiving, by the computing device, third location information for a second entity in the environment of the mobile robot, and determining, based on the second location information and the third location information, which of the first entity and the second entity is closer to the mobile robot. The one or more operating parameters can be based only on the first distance when it is determined that the first entity is closer to the mobile robot than the second entity. In some embodiments, the environment of the mobile robot includes a plurality of entities, and wherein an entity of the plurality of entities located closest to the mobile robot is selected as the first entity.

In some embodiments, the first location information for the mobile robot and/or the second location information for the first entity are based on data received from one or more sensors in communication with the computing device. In some embodiments, the one or more sensors include at least one of a LIDAR sensor, a RADAR sensor, an RF sensor, a laser range finding sensor, a Bluetooth sensor, or a location tracking tag. In some embodiments, the one or more sensors are configured to sense a specified region in the environment of the mobile robot. In some embodiments, the one or more sensors are attached to a sensor mount physically separate from the mobile robot. In some embodiments, at least one of the one or more sensors is mounted on a pitchable portion of a conveyor. In some embodiments, the sensor mount is attached to the conveyor.

In some embodiments, the first location information for the mobile robot is measured relative to one or more locations on or fixed relative to the sensor mount. In some embodiments, the second location information for the first entity is measured relative to one or more locations on or fixed relative to the sensor mount. In some embodiments, a line of sight between the one or more sensors and the mobile robot is located above a conveyor in the environment of the mobile robot. In some embodiments, the sensor mount is fixed relative to the environment. In some embodiments, the sensor mount includes at least one of a wireless access point, one or more cameras, one or more lights, or one or more fiducials. In some embodiments, the sensor mount is attached to a conveyor or a ground location in the environment of the mobile robot. In some embodiments, an end of the conveyor includes a fiducial. In some embodiments, the first location information for the mobile robot is based on a detected location of an end of the conveyor. In some embodiments, a dimension of the conveyor and a dimension of an object in the environment constrain the mobile robot to be located on one side of the end of the conveyor. In some embodiments, the first location information for the mobile robot is based on an extension length of the conveyor. In some embodiments, the extension length is determined using at least one of a rotational encoder, a linear encoder, a laser range finder, a LIDAR sensor, or a proximity sensor. In some embodiments, the method further comprises adjusting a sensing field of the one or more sensors based on at least one of (i) a position of the conveyor, (ii) a location of the mobile robot, (iii) a location of a bay in the environment of the mobile robot, or (iv) a position of the first entity. In some embodiments, the method further comprises controlling, by the computing device, the one or more sensors to sense a region located above an end of the conveyor.

In some embodiments, the method further comprises, controlling, by the computing device, the mobile robot to perform an emergency stop when the first distance is below a threshold distance. In some embodiments, the method further comprises, controlling, by the computing device, the mobile robot to perform an emergency stop when the second location information for the first entity indicates that the first entity is located in a specified safety zone. In some embodiments, the method further comprises, enforcing, by the mobile robot, the one or more operating parameters based on a motion plan of the mobile robot. In some embodiments, the motion plan is determined by the mobile robot. In some embodiments, the second location information for the first entity is based on a presence or absence of the first entity in a safety zone in the environment of the mobile robot. In some embodiments, the method further comprises commanding, by the computing device, a robotic arm of the mobile robot to assume a stowed position when the first entity is determined to be less than a threshold distance from the mobile robot.

In some embodiments, the mobile robot includes a mobile base. In some embodiments, the mobile robot includes at least one of a robotic manipulator or a robotic arm. In some embodiments, the method further comprises adjusting, by the computing device, a field of view of the one or more sensors based on a location of a conveyor in the environment of the mobile robot. In some embodiments, the method further comprises, adjusting, by the computing device, a field of view of the one or more sensors based on the first location information for the mobile robot and/or the second location information for the first entity. In some embodiments, the second location information for the first entity is based on information about a configuration of the environment of the mobile robot, the information including at least one of (i) a presence or absence of entities in a bay in the environment of the mobile robot, or (ii) a state of a door of the bay. In some embodiments, a physical guard is located between the first entity and the mobile robot, and the first distance is determined based on a path around the physical guard.

In another aspect, the invention features a computing system of a mobile robot. The computing system includes data processing hardware and memory hardware in communication with the data processing hardware. The memory hardware stores instructions that when executed on the data processing hardware cause the data processing hardware to perform operations. The operations include receiving first location information for the mobile robot, receiving second location information for a first entity in an environment of the mobile robot, determining based, at least in part, on the first location information and the second location information, a first distance between the mobile robot and the first entity in the environment of the mobile robot, and determining one or more operating parameters for the mobile robot, the one or more operating parameters based on the first distance.

In some embodiments, receiving first location information for the mobile robot comprises receiving sensor data indicating a location of the mobile robot. In some embodiments, receiving second location information for the first entity comprises receiving an indication that the first entity is located in a region defining a safety zone of the mobile robot. In some embodiments, the data processing hardware is included in the mobile robot. In some embodiments, the data processing hardware is included in a zone controller in communication with the mobile robot. In some embodiments, the operations further comprise communicating the one or more operating parameters to the mobile robot. In some embodiments, the operations further comprise controlling the mobile robot to move according to the one or more operating parameters.

In some embodiments, the one or more operating parameters comprise an operating speed limit. In some embodiments, the operating speed limit comprises a travel speed limit of a base of the mobile robot. In some embodiments, the operating speed limit comprises a speed limit of a point in space, the point in space located on an exterior surface of a robotic arm, a robotic manipulator, a robotic joint of the mobile robot, or an object manipulated by the mobile robot. In some embodiments, the one or more operating parameters comprise a stopping time limit. In some embodiments, the one or more operating parameters comprise an operating acceleration limit. In some embodiments, the operations further comprise setting the operating speed limit at a maximum operating speed limit when it is determined that the first entity is beyond a threshold distance from the mobile robot. In some embodiments, the operations further comprise setting the operating speed limit at a speed limit that is lower than a maximum operating speed limit when it is determined that the first entity is less than a threshold distance from the mobile robot. In some embodiments, the operations further comprise adjusting the operating speed limit when it is determined that the first entity has moved into or out of a safety zone.

In some embodiments, the first entity is determined, based on sensed data, to have a linear dimension of at least 70 mm in a plane located at least 100 mm above a ground plane. In some embodiments, the operations further comprise receiving a signal indicating that the first entity comprises an entity of concern. In some embodiments, the operations further comprise receiving a velocity of the first entity. The one or more operating parameters can be based on the velocity of the first entity. In some embodiments, the operations further comprise receiving an acceleration of the first entity, wherein the one or more operating parameters are based on the acceleration of the first entity. In some embodiments, the operations further comprise determining an operating acceleration limit of the mobile robot, the operating acceleration limit included in the one or more operating parameters for the mobile robot.

In some embodiments, the operations further comprise receiving third location information for a second entity in the environment of the mobile robot, and determining based on the third location information, a second distance between the mobile robot and the second entity. The one or more operating parameters can be based on a smaller distance of the first distance and the second distance. In some embodiments, the operations further comprise receiving third location information for a second entity in the environment of the mobile robot, and determining, based on the second location information and the third location information, which of the first entity and the second entity is closer to the mobile robot. The one or more operating parameters are based only on the first distance when it is determined that the first entity is closer to the mobile robot than the second entity. In some embodiments, the environment of the mobile robot includes a plurality of entities. An entity of the plurality of entities located closest to the mobile robot can be selected as the first entity.

In some embodiments, the first location information for the mobile robot and/or the second location information for the first entity are based on data received from one or more sensors. In some embodiments, the one or more sensors include at least one of a LIDAR sensor, a RADAR sensor, an RF sensor, a laser range finding sensor, a Bluetooth sensor, or a location tracking tag. In some embodiments, the one or more sensors are configured to sense a specified region in the environment of the mobile robot. In some embodiments, the one or more sensors are attached to a sensor mount physically separate from the mobile robot. In some embodiments, the first location information for the mobile robot is measured relative to one or more locations on or fixed relative to the sensor mount. In some embodiments, the second location information for the first entity is measured relative to one or more locations on or fixed relative to the sensor mount. In some embodiments, a line of sight between the one or more sensors and the mobile robot is located above a conveyor in the environment of the mobile robot. In some embodiments, the sensor mount is fixed relative to the environment. In some embodiments, the sensor mount includes at least one of a wireless access point, one or more cameras, one or more lights, or one or more fiducials. In some embodiments, at least one of the one or more sensors is mounted on a pitchable portion of a conveyor. In some embodiments, the sensor mount is attached to the conveyor.

In some embodiments, the sensor mount is attached to a conveyor or a ground location in the environment of the mobile robot. In some embodiments, an end of the conveyor includes a fiducial. In some embodiments, the first location information for the mobile robot is based on a detected location of an end of the conveyor. In some embodiments, a dimension of the conveyor and a dimension of an object in the environment constrain the mobile robot to be located on one side of the end of the conveyor. In some embodiments, the first location information for the mobile robot is based on an extension length of the conveyor. In some embodiments, the extension length is determined using at least one of a rotational encoder, a linear encoder, a laser range finder, a LIDAR sensor, or a proximity sensor. In some embodiments, the operations further comprise adjusting a sensing field of the one or more sensors based on at least one of (i) a position of the conveyor, (ii) a location of the mobile robot, (iii) a location of a bay in the environment of the mobile robot, or (iv) a position of the first entity. In some embodiments, the operations further comprise controlling the one or more sensors to sense a region located above an end of the conveyor.

In some embodiments, the operations further comprise controlling the mobile robot to perform an emergency stop when the first distance is below a threshold distance. In some embodiments, the operations further comprise controlling the mobile robot to perform an emergency stop when the second location information for the first entity indicates that the first entity is located in a specified safety zone. In some embodiments, the operations further comprise enforcing the one or more operating parameters based on a motion plan of the mobile robot. In some embodiments, the motion plan is determined by the mobile robot. In some embodiments, the second location information for the first entity is based on a presence or absence of the first entity in a safety zone in the environment of the mobile robot. In some embodiments, the operations further comprise commanding a robotic arm of the mobile robot to assume a stowed position when the first entity is determined to be less than a threshold distance from the mobile robot.

In some embodiments, the mobile robot includes a mobile base. In some embodiments, the mobile robot includes at least one of a robotic manipulator or a robotic arm. In some embodiments, the operations further comprise adjusting a field of view of the one or more sensors based on a location of a conveyor in the environment of the mobile robot. In some embodiments, the operations further comprise adjusting a field of view of the one or more sensors based on the first location information for the mobile robot and/or the second location information for the first entity. In some embodiments, the second location information for the first entity is based on information about a configuration of the environment of the mobile robot, the information including at least one of (i) a presence or absence of entities in a bay in the environment of the mobile robot, or (ii) a state of a door of the bay. In some embodiments, a physical guard is located between the first entity and the mobile robot, and wherein the first distance is determined based on a path around the physical guard.

In some embodiments, the computing system further includes the mobile robot. In some embodiments, the computing system further includes a mount including one or more sensors configured to sense a distance to the mobile robot. In some embodiments, the mount includes one or more sensors configured to sense a distance to the first entity.

### BRIEF DESCRIPTION OF DRAWINGS

The advantages of the invention, together with further advantages, may be better understood by referring to the following description taken in conjunction with the accompanying drawings. The drawings are not necessarily to scale, and emphasis is instead generally placed upon illustrating the principles of the invention.

FIGS. 1A and 1B are perspective views of a robot, according to an illustrative embodiment of the invention.

FIG. 2A depicts robots performing different tasks within a warehouse environment, according to an illustrative embodiment of the invention.

FIG. 2B depicts a robot unloading boxes from a truck and placing them on a conveyor belt, according to an illustrative embodiment of the invention.

FIG. 2C depicts a robot performing an order building task in which the robot places boxes onto a pallet, according to an illustrative embodiment of the invention.

FIG. 3 is a perspective view of a robot, according to an illustrative embodiment of the invention.

FIG. 4 is a schematic view of a robot and an entity in an environment of the robot separated by a distance d, according to an illustrative embodiment of the invention.

FIG. 5 is an illustration of a robot and parcel handling equipment during operation, according to an illustrative embodiment of the invention.

FIG. 6 is an illustration of a robot and parcel handling equipment having additional features, according to an illustrative embodiment of the invention.

FIGS. 7A-7C illustrate different systems and methods of sensing a distance to a robot, according to an illustrative embodiment of the invention.

FIG. 8 is a schematic illustration of different configurations of a robot and an entity in the environment of the robot that can lead to different operating parameters for the robot, according to an illustrative embodiment of the invention.

FIG. 9A is an illustration of a telescopic conveyor having a sensing arch in an environment of a robot located near a loading bay, according to an illustrative embodiment of the invention.

FIG. 9B is an illustration of multiple telescopic conveyors servicing multiple bays, with each bay monitored by respective sensors, according to an illustrative embodiment of the invention.

FIG. 9C is an illustration of multiple telescopic conveyors servicing multiple bays, with physical guards protecting one or more bays, according to an illustrative embodiment of the invention.

FIG. 9D is an illustration of a robot unloading a container onto an accordion conveyor, according to an illustrative embodiment of the invention.

FIG. 9E is a top down illustration of a telescopic conveyor configured to move laterally between bays, according to an illustrative embodiment of the invention.

FIG. 9F is an illustration of a telescopic conveyor having a sensing arch coupled thereto, according to an illustrative embodiment of the invention.

FIG. 10 is a flow diagram of a method according to an illustrative embodiment of the invention.

FIG. 11 illustrates an example configuration of a robotic device, according to an illustrative embodiment of the invention.

### DETAILED DESCRIPTION

Robots can be configured to perform a number of tasks in an environment in which they are placed. Exemplary tasks may include interacting with objects and/or elements of the environment. Notably, robots are becoming popular in warehouse and logistics operations. Before robots were introduced to such spaces, many operations were performed manually. For example, a person might manually unload boxes from a truck onto one end of a conveyor belt, and a second person at the opposite end of the conveyor belt might organize those boxes onto a pallet. The pallet might then be picked up by a forklift operated by a third person, who might drive to a storage area of the warehouse and drop the pallet for a fourth person to remove the individual boxes from the pallet and place them on shelves in a storage area. Some robotic solutions have been developed to automate many of these functions. Such robots may either be specialist robots (i.e., designed to perform a single task or a small number of related tasks) or generalist robots (i.e., designed to perform a wide variety of tasks). To date, both specialist and generalist warehouse robots have been associated with significant limitations.

For example, because a specialist robot may be designed to perform a single task (e.g., unloading boxes from a truck onto a conveyor belt), while such specialized robots may be efficient at performing their designated task, they may be unable to perform other related tasks. As a result, either a person or a separate robot (e.g., another specialist robot designed for a different task) may be needed to perform the next task(s) in the sequence. As such, a warehouse may need to invest in multiple specialized robots to perform a sequence of tasks, or may need to rely on a hybrid operation in which there are frequent robot-to-human or human-to-robot handoffs of objects.

In contrast, while a generalist robot may be designed to perform a wide variety of tasks (e.g., unloading, palletizing, transporting, depalletizing, and/or storing), such generalist robots may be unable to perform individual tasks with high enough efficiency or accuracy to warrant introduction into a highly streamlined warehouse operation. For example, while mounting an off-the-shelf robotic manipulator onto an off-the-shelf mobile robot might yield a system that could, in theory, accomplish many warehouse tasks, such a loosely integrated system may be incapable of performing complex or dynamic motions that require coordination between the manipulator and the mobile base, resulting in a combined system that is inefficient and inflexible.

Typical operation of such a system within a warehouse environment may include the mobile base and the manipulator operating sequentially and (partially or entirely) independently of each other. For example, the mobile base may first drive toward a stack of boxes with the manipulator powered down. Upon reaching the stack of boxes, the mobile base may come to a stop, and the manipulator may power up and begin manipulating the boxes as the base remains stationary. After the manipulation task is completed, the manipulator may again power down, and the mobile base may drive to another destination to perform the next task.

In such systems, the mobile base and the manipulator may be regarded as effectively two separate robots that have been joined together. Accordingly, a controller associated with the manipulator may not be configured to share information with, pass commands to, or receive commands from a separate controller associated with the mobile base. As such, such a poorly integrated mobile manipulator robot may be forced to operate both its manipulator and its base at suboptimal speeds or through suboptimal trajectories, as the two separate controllers struggle to work together. Additionally, while certain limitations arise from an engineering perspective, additional limitations must be imposed to comply with safety regulations. For example, if a safety regulation requires that a mobile manipulator must be able to be completely shut down within a certain period of time when a human enters a region within a certain distance of the robot, a loosely integrated mobile manipulator robot may not be able to act sufficiently quickly to ensure that both the manipulator and the mobile base (individually and in aggregate) do not threaten the human. To ensure that such loosely integrated systems operate within required safety constraints, such systems are forced to operate at even slower speeds or to execute even more conservative trajectories than those limited speeds and trajectories as already imposed by the engineering problem. As such, the speed and efficiency of generalist robots performing tasks in warehouse environments to date have been limited.

In view of the above, a highly integrated mobile manipulator robot with system-level mechanical design and holistic control strategies between the manipulator and the mobile base may provide certain benefits in warehouse and/or logistics operations. Such an integrated mobile manipulator robot may be able to perform complex and/or dynamic motions that are unable to be achieved by conventional, loosely integrated mobile manipulator systems. As a result, this type of robot may be well suited to perform a variety of different tasks (e.g., within a warehouse environment) with speed, agility, and efficiency.

### Example Robot Overview

In this section, an overview of some components of one embodiment of a highly integrated mobile manipulator robot configured to perform a variety of tasks is provided to explain the interactions and interdependencies of various subsystems of the robot. Each of the various subsystems, as well as control strategies for operating the subsystems, are described in further detail in the following sections.

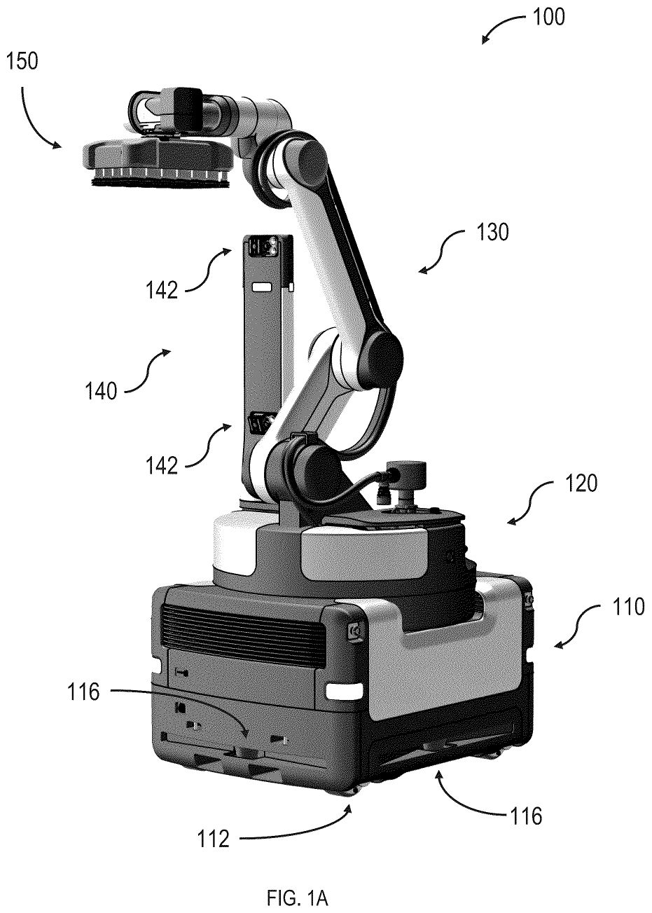

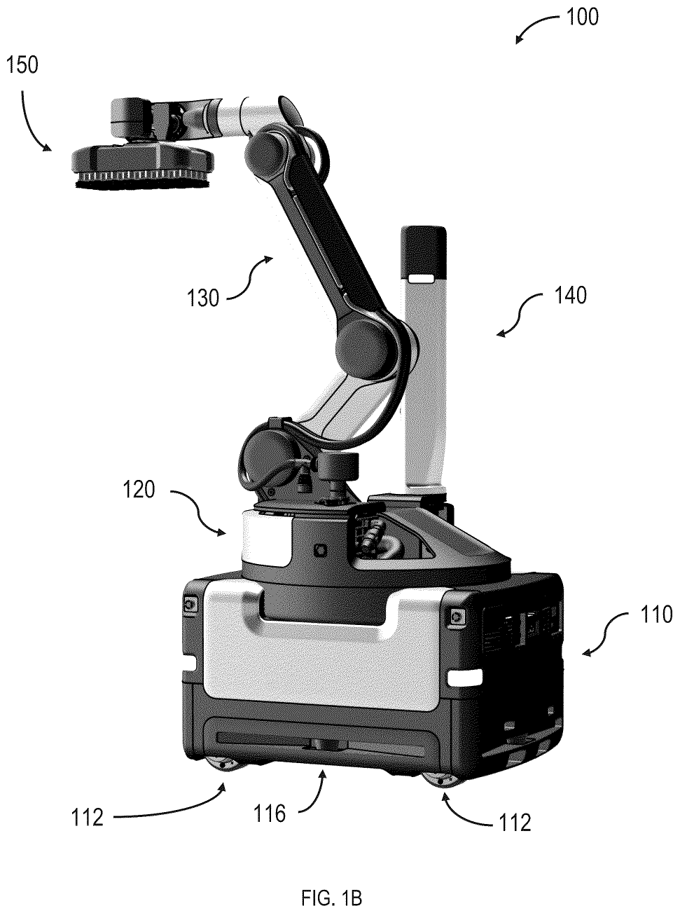

FIGS. 1A and 1B are perspective views of a robot 100, according to an illustrative embodiment of the invention. The robot 100 includes a mobile base 110 and a robotic arm 130. The mobile base 110 includes an omnidirectional drive system that enables the mobile base to translate in any direction within a horizontal plane as well as rotate about a vertical axis perpendicular to the plane. Each wheel 112 of the mobile base 110 is independently steerable and independently drivable. The mobile base 110 additionally includes a number of distance sensors 116 that assist the robot 100 in safely moving about its environment. The robotic arm 130 is a 6 degree of freedom (6-DOF) robotic arm including three pitch joints and a 3-DOF wrist. An end effector 150 is disposed at the distal end of the robotic arm 130. The robotic arm 130 is operatively coupled to the mobile base 110 via a turntable 120, which is configured to rotate relative to the mobile base 110. In addition to the robotic arm 130, a perception mast 140 is also coupled to the turntable 120, such that rotation of the turntable 120 relative to the mobile base 110 rotates both the robotic arm 130 and the perception mast 140. The robotic arm 130 is kinematically constrained to avoid collision with the perception mast 140. The perception mast 140 is additionally configured to rotate relative to the turntable 120, and includes a number of perception modules 142 configured to gather information about one or more objects in the robot's environment. The integrated structure and system-level design of the robot 100 enable fast and efficient operation in a number of different applications, some of which are provided below as examples.

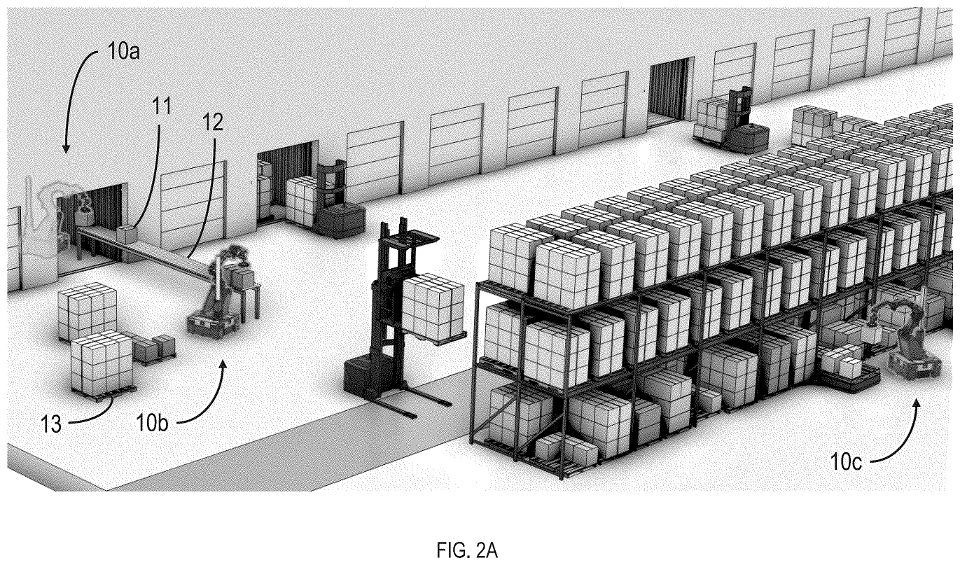

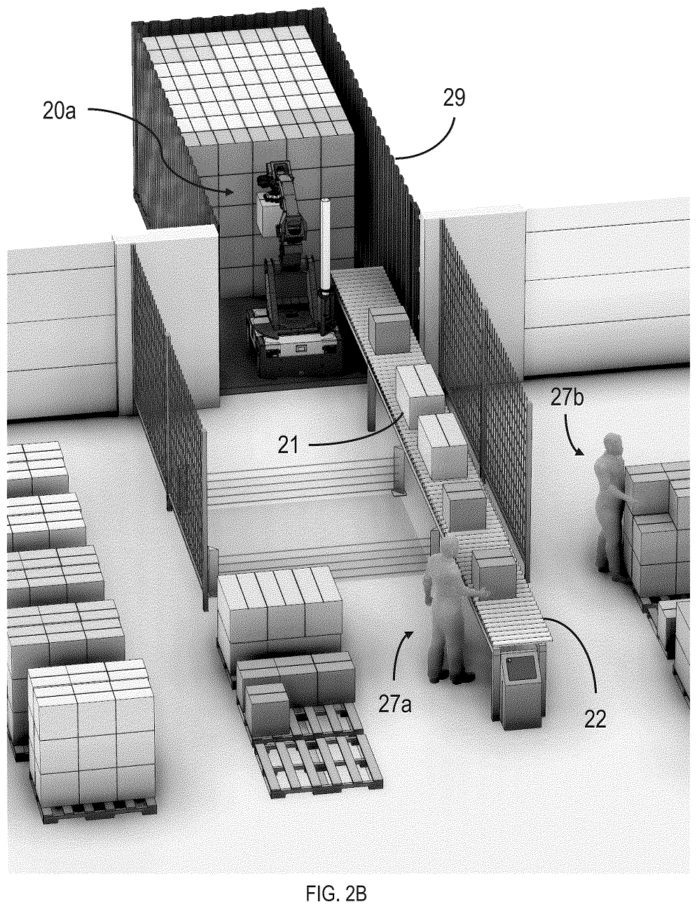

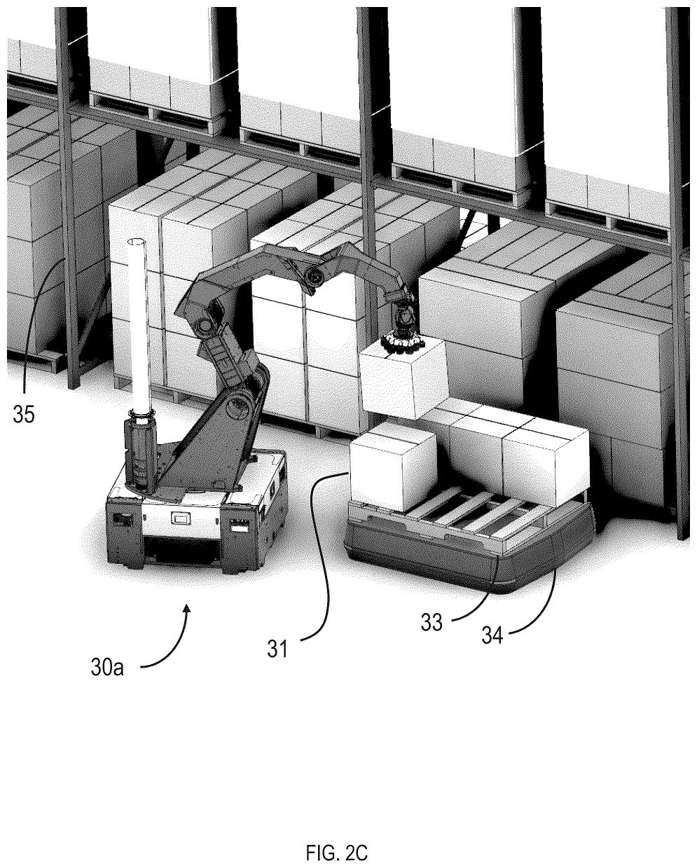

FIG. 2A depicts robots 10a, 10b, and 10c performing different tasks within a warehouse environment. A first robot 10a is inside a truck (or a container), moving boxes 11 from a stack within the truck onto a conveyor belt 12 (this particular task will be discussed in greater detail below in reference to FIG. 2B). At the opposite end of the conveyor belt 12, a second robot 10b organizes the boxes 11 onto a pallet 13. In a separate area of the warehouse, a third robot 10c picks boxes from shelving to build an order on a pallet (this particular task will be discussed in greater detail below in reference to FIG. 2C). The robots 10a, 10b, and 10c can be different instances of the same robot or similar robots. Accordingly, the robots described herein may be understood as specialized multi-purpose robots, in that they are designed to perform specific tasks accurately and efficiently, but are not limited to only one or a small number of tasks.

FIG. 2B depicts a robot 20a unloading boxes 21 from a truck 29 and placing them on a conveyor belt 22. In this box picking application (as well as in other box picking applications), the robot 20a repetitiously picks a box, rotates, places the box, and rotates back to pick the next box. Although robot 20a of FIG. 2B is a different embodiment from robot 100 of FIGS. 1A and 1B, referring to the components of robot 100 identified in FIGS. 1A and 1B will ease explanation of the operation of the robot 20a in FIG. 2B.

During operation, the perception mast of robot 20a (analogous to the perception mast 140 of robot 100 of FIGS. 1A and 1B) may be configured to rotate independently of rotation of the turntable (analogous to the turntable 120) on which it is mounted to enable the perception modules (akin to perception modules 142) mounted on the perception mast to capture images of the environment that enable the robot 20a to plan its next movement while simultaneously executing a current movement. For example, while the robot 20a is picking a first box from the stack of boxes in the truck 29, the perception modules on the perception mast may point at and gather information about the location where the first box is to be placed (e.g., the conveyor belt 22). Then, after the turntable rotates and while the robot 20a is placing the first box on the conveyor belt, the perception mast may rotate (relative to the turntable) such that the perception modules on the perception mast point at the stack of boxes and gather information about the stack of boxes, which is used to determine the second box to be picked. As the turntable rotates back to allow the robot to pick the second box, the perception mast may gather updated information about the area surrounding the conveyor belt. In this way, the robot 20a may parallelize tasks which may otherwise have been performed sequentially, thus enabling faster and more efficient operation.

Also of note in FIG. 2B is that the robot 20a is working alongside humans (e.g., workers 27a and 27b). Given that the robot 20a is configured to perform many tasks that have traditionally been performed by humans, the robot 20a is designed to have a small footprint, both to enable access to areas designed to be accessed by humans, and to minimize the size of a safety zone around the robot (e.g., into which humans are prevented from entering and/or which are associated with other safety controls, as explained in greater detail below).

FIG. 2C depicts a robot 30a performing an order building task, in which the robot 30a places boxes 31 onto a pallet 33. In FIG. 2C, the pallet 33 is disposed on top of an autonomous mobile robot (AMR) 34, but it should be appreciated that the capabilities of the robot 30a described in this example apply to building pallets not associated with an AMR. In this task, the robot 30a picks boxes 31 disposed above, below, or within shelving 35 of the warehouse and places the boxes on the pallet 33. Certain box positions and orientations relative to the shelving may suggest different box picking strategies. For example, a box located on a low shelf may simply be picked by the robot by grasping a top surface of the box with the end effector of the robotic arm (thereby executing a “top pick”). However, if the box to be picked is on top of a stack of boxes, and there is limited clearance between the top of the box and the bottom of a horizontal divider of the shelving, the robot may opt to pick the box by grasping a side surface (thereby executing a “face pick”).

To pick some boxes within a constrained environment, the robot may need to carefully adjust the orientation of its arm to avoid contacting other boxes or the surrounding shelving. For example, in a typical “keyhole problem”, the robot may only be able to access a target box by navigating its arm through a small space or confined area (akin to a keyhole) defined by other boxes or the surrounding shelving. In such scenarios, coordination between the mobile base and the arm of the robot may be beneficial. For instance, being able to translate the base in any direction allows the robot to position itself as close as possible to the shelving, effectively extending the length of its arm (compared to conventional robots without omnidirectional drive which may be unable to navigate arbitrarily close to the shelving). Additionally, being able to translate the base backwards allows the robot to withdraw its arm from the shelving after picking the box without having to adjust joint angles (or minimizing the degree to which joint angles are adjusted), thereby enabling a simple solution to many keyhole problems.

The tasks depicted in FIGS. 2A-2C are only a few examples of applications in which an integrated mobile manipulator robot may be used, and the present disclosure is not limited to robots configured to perform only these specific tasks. For example, the robots described herein may be suited to perform tasks including, but not limited to: removing objects from a truck or container; placing objects on a conveyor belt; removing objects from a conveyor belt; organizing objects into a stack; organizing objects on a pallet; placing objects on a shelf; organizing objects on a shelf; removing objects from a shelf; picking objects from the top (e.g., performing a “top pick”); picking objects from a side (e.g., performing a “face pick”); coordinating with other mobile manipulator robots; coordinating with other warehouse robots (e.g., coordinating with AMRs); coordinating with humans; and many other tasks.

### Example Robotic Arm

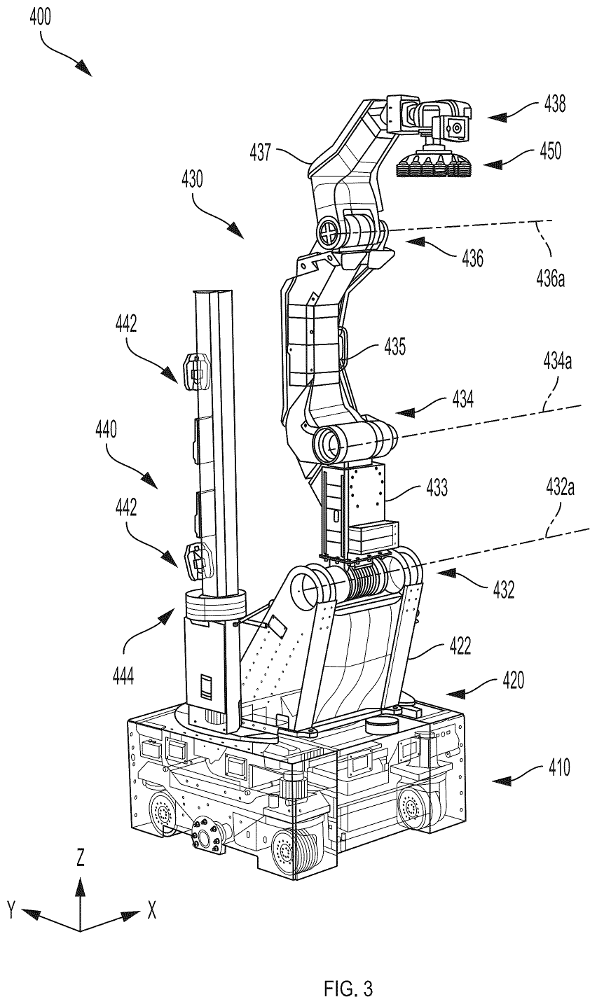

FIG. 3 is a perspective view of a robot 400, according to an illustrative embodiment of the invention. The robot 400 includes a mobile base 410 and a turntable 420 rotatably coupled to the mobile base. A robotic arm 430 is operatively coupled to the turntable 420, as is a perception mast 440. The perception mast 440 includes an actuator 444 configured to enable rotation of the perception mast 440 relative to the turntable 420 and/or the mobile base 410, so that a direction of the perception modules 442 of the perception mast may be independently controlled.

The robotic arm 430 of FIG. 3 is a 6-DOF robotic arm. When considered in conjunction with the turntable 420 (which is configured to yaw relative to the mobile base about a vertical axis parallel to the Z axis), the arm/turntable system may be considered a 7-DOF system. The 6-DOF robotic arm 430 includes three pitch joints 432, 434, and 436, and a 3-DOF wrist 438 which, in some embodiments, may be a spherical 3-DOF wrist.

Starting at the turntable 420, the robotic arm 430 includes a turntable offset 422, which is fixed relative to the turntable 420. A distal portion of the turntable offset 422 is rotatably coupled to a proximal portion of a first link 433 at a first joint 432. A distal portion of the first link 433 is rotatably coupled to a proximal portion of a second link 435 at a second joint 434. A distal portion of the second link 435 is rotatably coupled to a proximal portion of a third link 437 at a third joint 436. The first, second, and third joints 432, 434, and 436 are associated with first, second, and third axes 432a, 434a, and 436a, respectively.

The first, second, and third joints 432, 434, and 436 are additionally associated with first, second, and third actuators (not labeled) which are configured to rotate a link about an axis. Generally, the nth actuator is configured to rotate the nth link about the nth axis associated with the nth joint. Specifically, the first actuator is configured to rotate the first link 433 about the first axis 432a associated with the first joint 432, the second actuator is configured to rotate the second link 435 about the second axis 434a associated with the second joint 434, and the third actuator is configured to rotate the third link 437 about the third axis 436a associated with the third joint 436. In the embodiment shown in FIG. 3, the first, second, and third axes 432a, 434a, and 436a are parallel (and, in this case, are all parallel to the X axis). In the embodiment shown in FIG. 3, the first, second, and third joints 432, 434, and 436 are all pitch joints.

In some embodiments, a robotic arm of a highly integrated mobile manipulator robot may include a different number of degrees of freedom than the robotic arms discussed above. Additionally, a robotic arm need not be limited to a robotic arm with three pitch joints and a 3-DOF wrist. A robotic arm of a highly integrated mobile manipulator robot may include any suitable number of joints of any suitable type, whether revolute or prismatic. Revolute joints need not be oriented as pitch joints, but rather may be pitch, roll, yaw, or any other suitable type of joint.

Returning to FIG. 3, the robotic arm 430 includes a wrist 438. As noted above, the wrist 438 is a 3-DOF wrist, and in some embodiments may be a spherical 3-DOF wrist. The wrist 438 is coupled to a distal portion of the third link 437. The wrist 438 includes three actuators configured to rotate an end effector 450 coupled to a distal portion of the wrist 438 about three mutually perpendicular axes. Specifically, the wrist may include a first wrist actuator configured to rotate the end effector relative to a distal link of the arm (e.g., the third link 437) about a first wrist axis, a second wrist actuator configured to rotate the end effector relative to the distal link about a second wrist axis, and a third wrist actuator configured to rotate the end effector relative to the distal link about a third wrist axis. The first, second, and third wrist axes may be mutually perpendicular. In embodiments in which the wrist is a spherical wrist, the first, second, and third wrist axes may intersect.

In some embodiments, an end effector may be associated with one or more sensors. For example, a force/torque sensor may measure forces and/or torques (e.g., wrenches) applied to the end effector. Alternatively or additionally, a sensor may measure wrenches applied to a wrist of the robotic arm by the end effector (and, for example, an object grasped by the end effector) as the object is manipulated. Signals from these (or other) sensors may be used during mass estimation and/or path planning operations. In some embodiments, sensors associated with an end effector may include an integrated force/torque sensor, such as a 6-axis force/torque sensor. In some embodiments, separate sensors (e.g., separate force and torque sensors) may be employed. Some embodiments may include only force sensors (e.g., uniaxial force sensors, or multi-axis force sensors), and some embodiments may include only torque sensors. In some embodiments, an end effector may be associated with a custom sensing arrangement. For example, one or more sensors (e.g., one or more uniaxial sensors) may be arranged to enable sensing of forces and/or torques along multiple axes. An end effector (or another portion of the robotic arm) may additionally include any appropriate number or configuration of cameras, distance sensors, pressure sensors, light sensors, or any other suitable sensors, whether related to sensing characteristics of the payload or otherwise, as the disclosure is not limited in this regard.

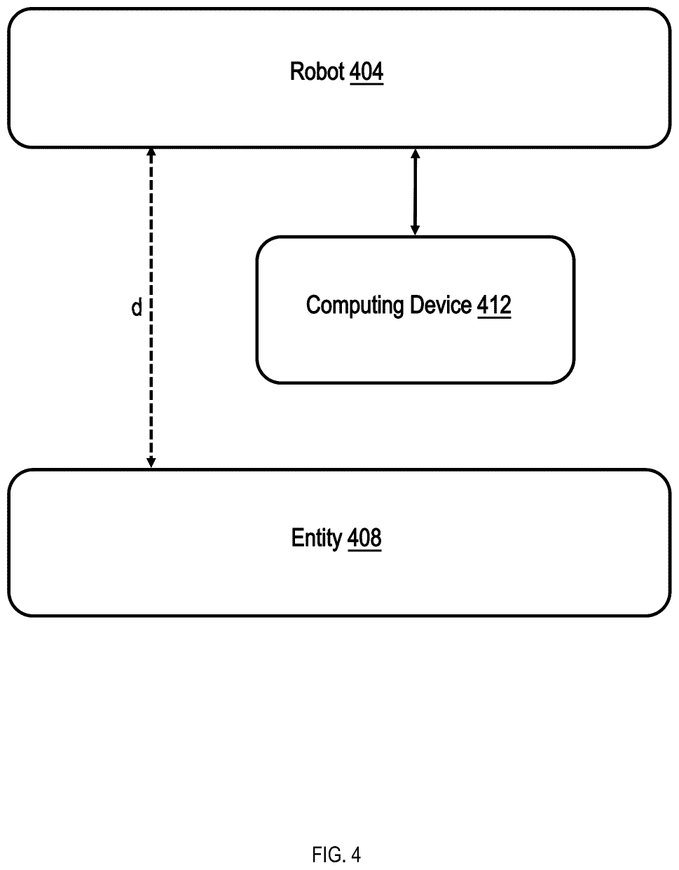

FIG. 4 is a schematic view of a robot 404 (e.g., a mobile manipulator robot, as described in FIGS. 1-3 above) and an entity 408 (e.g., a human or other robot) in an environment of the robot 404, according to an illustrative embodiment of the invention. The entity 408 is separated from the robot 404 by a distance d. A computing device 412 is in communication with the robot 404. In FIG. 4, the computing device 412 is shown as a separate component from the robot 404, and may be included, for example, in a zone controller that is in communication with the robot 404 (e.g., as described in greater detail in FIG. 6 below). However, in some embodiments, the computing device 412 can be included in, on, or as a part of the robot 404 itself.

During operation, the computing device 412 receives location information for the robot 404. The location information may include any direct or indirect location measurements that enable the robot 404 to be localized in its environment. For instance, the location information may include coordinates of the robot 404 with reference to a map of the environment of the robot 404 or with reference to some other coordinate system (e.g., a global positioning satellite (GPS) coordinate system). Alternatively, the location information may include distance information between the robot 404 and a first sensor. The first sensor may be coupled to or otherwise associated with equipment (e.g., a conveyor) with which the robot 404 is working and/or the first sensor may be a sensor configured to more generally monitor aspects of an environment within which the robot is operating (e.g., a global “eye-in-the-sky” sensor arranged to monitor a warehouse environment). The computing device 412 also receives location information for the entity 408. The location information for the entity 408 may be determined in a similar manner as the location information for the robot 404 (e.g., coordinates relative to a map, distance from a sensor) or in a different way. In some embodiments, a first distance included in the location information for the robot is sensed by a first sensor and a second distance included in the location information for the robot is sensed by a second sensor, which may or may not be the same as the first sensor. The computing device 412 determines a distance d between the robot 404 and the entity 408. The distance is based on the location information for the robot 404 and/or the location information for the entity 408. The computing device 412 determines one or more operating parameters for the robot 404 (e.g., a maximum safe operating speed for the arm and/or a maximum safe travel speed for the base of the robot 404). The one or more operating parameters are based on the distance d (e.g., a maximum safe operating speed can be set lower when the distance d is small and higher when the distance d is larger). In some embodiments, the one or more operating parameters are based on a sliding scale according to the distance d. The computing device 412 communicates the one or more operating parameters to the robot 404 (or a control system of the robot 404) and/or controls the robot 404 to move according to the one or more operating parameters. The operating parameters can be enforced on the robot 404 using reliable methods.

In some embodiments, the distance d represents a minimum distance between the robot 404 and the entity 408 (e.g., any uncertainties in the location information for the robot 404 and/or the entity 408 can be resolved conservatively in favor of calculating the smallest possible distance consistent with the received location information). In some embodiments, more than one entity is monitored and/or location information is received for more than one entity. In some embodiments, the distance d can represent a distance between the robot 404 and the entity 408 that imposes the most restrictive relevant safety constraint (e.g., the closest entity, or the entity approaching the robot 404 the fastest, even if that entity is somewhat further away). In some embodiments, multiple distances (e.g., d1, d2, etc.) can be determined separately based on location information for each entity sensed. In some embodiments, the operating parameters can be based on some or all of the multiple distances. In some embodiments, the operating parameters can be based on variables other than distance as well including, but not limited to, speed, velocity, and/or acceleration of the corresponding entities.

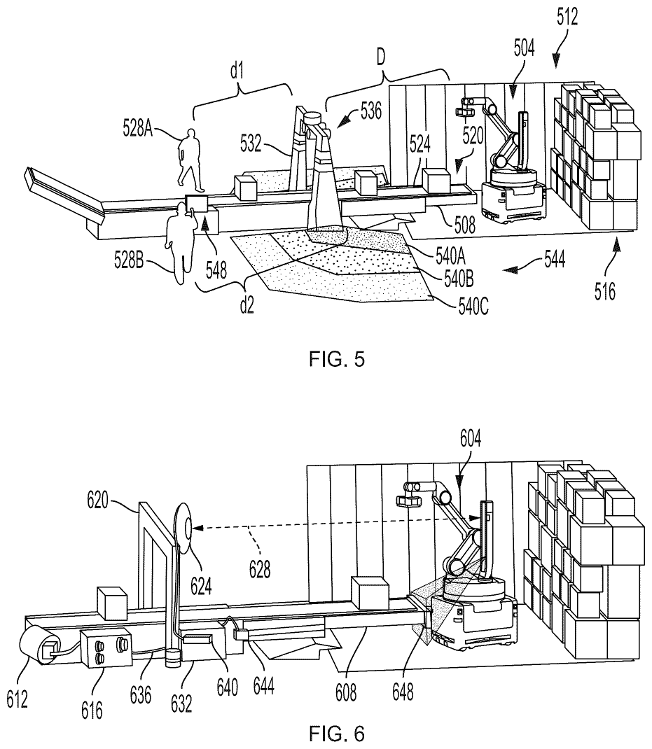

FIG. 5 is an illustration of a robot 504 and parcel handling equipment (here, a telescopic conveyor) 508 during operation, according to an illustrative embodiment of the invention. The robot 504 is located in a bay 512 and is moving boxes from a first region 516 (e.g., a stack of boxes) to a second region 520 (e.g., on a belt 524 of the conveyor 508). One or more entities 528 (here, two people 528A, 528B) are in the environment of the robot 504. In FIG. 5, the conveyor 508 is surrounded by a mount 532 (here a sensing arch, although other structures are possible), which includes one or more sensors 536 for determining location information for the one or more entities 528 and/or location information for the robot 504. In some embodiments, the sensors 536 can include one or more cameras, LIDAR sensors, RADAR sensors, RF sensors, laser range finding sensors, Bluetooth sensors, RFID tags, and/or location tracking tags. In some embodiments, the mount 532 holds one or more lights (e.g., to indicate to a human when a safety zone is violated, when the robot 504 is slowing, and/or on which side of the conveyor 508 there has been a breach). When the one or more lights are illuminated, the cause of the illuminated light(s) can be investigated and an appropriate action can be performed. For instance, the information provided by the illuminated light(s) may inform one or more entities (e.g., people 528A, 528B) that they are within the safety zone and/or may inform a human about an object (e.g., a misplaced pallet or piece of debris) located within a safety zone, which may have triggered the illumination, and should be cleared from the area to prevent further false positive illuminations. In some embodiments, when the one or more lights are illuminated, one or more cameras (e.g., a camera mounted on the robot 504, a camera mounted in the environment within which the robot 504 is working, etc.) may be instructed to capture one or more images of the environment including the safety zone, and the image(s) may be analyzed (e.g., using one or more image processing algorithms) to characterize and/or identify an object and/or an entity in the image(s) to facilitate determination of the cause of the light illumination. In some embodiments, the mount 532 holds additional features such as a wireless network access point (e.g., as shown and described below in FIG. 6).

During operation, a computing device (not shown in FIG. 5, but an example of which is computing device 412 shown and described in FIG. 4) receives location information for the robot 504 (e.g., a distance D as measured from the one or more sensors 536 to the robot 504). The computing device also receives location information for one or more of the entities 528A, 528B (e.g., distances d1 and/or d2 as measured from one or more sensors 536 to the robot 504). The computing device uses this information to determine a distance between the robot 504 and at least one of the one or more entities 528A, 528B. Based on the determined distance, the computing device determines one or more operating parameters for the robot 504. The computing device can communicate the one or more operating parameters to the robot 504 and/or control the robot 504 to move according to the one or more operating parameters.

Depending on the particular configuration, there may be multiple ways to determine a distance between the robot 504 and at least one of the one or more entities 528A, 528B. In some embodiments, the smaller distance of the two distances d1 and d2 can be used to determine the operating parameters of the robot 504. In some embodiments, the smaller distance may not necessarily be used, e.g., if the closest entity (e.g., entity 528A) is moving toward the robot 504 relatively slowly (or away from the robot), while an entity located farther from the robot 504 (e.g., entity 528B) is moving sufficiently faster than the closest entity toward the robot 504, thereby creating a greater safety risk. In some embodiments, a velocity of each entity is measured directly (e.g., using measurements of position over time or sensors that measure velocity directly). In some embodiments, each entity is classified into a class (e.g., person on foot, forklift, static object, trained operator, etc.), and one or more characteristics (e.g., top velocity, top acceleration, etc.) may be inferred based on the classification. In some embodiments, classification is performed via one or more known techniques (e.g., using machine vision methods using cameras, thermal cameras, identification tags with RF and/or visible features, etc.) In some embodiments, other systems may assist in classification tasks (e.g., a warehouse-wide security camera array having a computing system configured to track people over time). In some embodiments, the classification is highly reliable, and maximum speeds can be based on that information. In some embodiments, the classification is reasonably reliable, and robots can be slowed and/or monitored fields reduced ahead of an actual breach that would otherwise cause an operational stop and/or emergency stop.

Also depicted in FIG. 5 are multiple safety zones 540 (here, 540A, 540B, 540C) on a ground plane 544 of the environment of the robot 504 (e.g., which entities can potentially occupy and/or traverse). In FIG. 5, the safety zone 540A closest to the robot 504 can represent a first region (e.g., a location or set of locations, such as an area on a plane located about 200 mm above a ground plane, or a volume of space, that one or more entities could occupy) closest to the robot 504, while another safety zone 540B can represent a second region further away from the robot 504, and another safety zone 540C can represent a third region still further away from the robot 504. In some embodiments, location information can be processed to indicate a presence (or absence) of an entity in a safety zone 540 closer to the robot 504 (e.g., safety zone 540A). In such a situation, one set of operating parameters can be determined (e.g., a more conservative set), while location information indicating a presence of an entity in a safety zone further from the robot 504 (e.g., safety zone 540C) can result in a second set of operating parameters (e.g., a less conservative set).

In some embodiments, the one or more operating parameters comprise one or more operating speed limits, such as a travel speed limit of a mobile base of the robot and/or a speed limit of a relevant point in space (e.g., a point located on an exterior surface of a robotic arm, a robotic manipulator, a robotic joint of the robot, or an objected manipulated by the robot). In some embodiments, the one or more operating parameters comprise an operating velocity and/or an acceleration limit. In some embodiments, the computing device receives a velocity and/or an acceleration of the entity, and the one or more operating parameters are based on the velocity and/or the acceleration (e.g., a current velocity and/or acceleration, an immediately prior velocity and/or acceleration, or another suitable vector.). In some embodiments, the computing device determines an operating velocity and/or acceleration limit of the robot, and the operating velocity and/or acceleration limit are included in the set of operating parameters for the robot. In some embodiments, the set of operating parameters comprises one or more stopping time limits (e.g., such that the robot 504 comes to a stop within the stopping time limit and/or the onboard safety systems of the robot 504 would observe the configuration and/or velocities of the robot 504 to confirm it is operating within the stopping time limit).

In some embodiments, the safety zones 540 are administered by a safety system such as a zone controller (e.g., the zone controller 632 shown and described below in FIG. 6). In some embodiments, location information indicating that an entity occupies any part of a particular safety zone can be interpreted as the entity occupying the closest portion of the zone to the robot (e.g., for ease of computation, compatibility with existing zone controllers, and/or conservative calculations in view of the associated safety concerns). In some embodiments, some or all sensed location information can be provided to the zone controller so that the distances are computed based on conservative approximations of relevant distances.

In some embodiments, the presence or absence of a particular kind of entity of concern can be determined based on one or more sensed characteristics of that entity. For example, a sensed entity may be identified as a human if the sensed characteristics of the entity are consistent with the size (e.g., dimensions) or shape of a human (e.g., an average human, a child, an adult, etc.). For instance, in some embodiments a human can be identified if the entity is sensed to have a linear dimension of at least 70 mm in a plane located at least 100 mm above a ground plane. In another example, human operators working in the vicinity of robots can be required to wear electronic identifiers, and receipt of a signal indicating that such an identifier is within a threshold distance can trigger suitable action by the robot 504. In some embodiments, the robot 504 can be controlled to perform an emergency stop when it is determined that an entity of concern is within a certain threshold distance of the robot 504 and/or is located within a certain safety zone. In some embodiments, the conveyor 508 includes a control station 548 (with which operator 528B is interacting), which can be used to control the robot 504 and/or other equipment within the environment within which the robot 504 is working. The control station 548 may be located outside of the monitored regions 540A-C (e.g., so that the robot 504 is not inadvertently slowed down by detection of operator 528B being within a monitored region).

FIG. 6 is an illustration of a robot 604 and parcel handling equipment (here, a telescopic conveyor) 608 having additional features, according to an illustrative embodiment of the invention. As shown, the conveyor 608 is a telescopic conveyor, although other conveyors (e.g., a boom conveyor, an accordion conveyor, or a gravity conveyor) or other parcel handling equipment are also possible. The conveyor 608 can include a motor drive 612 (e.g., a variable-frequency drive), which may have on-board motion controls (e.g., hold-to-run controls) with speed and/or acceleration limits. The conveyor 608 can also include a cabinet 616 in communication with the motor drive 612. The cabinet 616 can include one or more relays and/or motion controls (e.g., a forward control, a reverse control, an emergency stop control, and/or a reset control). In some embodiments, the cabinet 616 can include a programmable logic controller (PLC).

A mount 620 (here a sensing arch) can be disposed relative to the conveyor 608 (here, surrounding it on two sides, although other structures are possible). The mount 620 can include one or more additional components. In some embodiments, the mount 620 holds a wireless access point 624, which can be used for communicating with the robot 604 (e.g., using a black-channel for safety-related data transmission and/or an ADS layer for other functions). In some embodiments, the mount 620 holds one or more sensors, such as a camera, a LIDAR sensor, a RADAR sensor, a RF sensor, a laser range finding sensor, a Bluetooth sensor, a RFID tag, and/or a location tracking tag. In some embodiments, the one or more sensors are configured to sense the location information for the robot 604 and/or one or more entities in the environment of the robot 604 (e.g., as shown and described above in FIG. 5). In some embodiments, a line of sight 628 between the mount 620 and the robot 604 enables the robot 604 to be located reliably in the environment. In some embodiments, the mount 620 holds one or more fiducials (e.g., identifying the mount 620 and/or one or more properties of the mount 620). In some embodiments, the mount 620 holds one or more lights (e.g., for providing additional illumination of the robot 604, conveyor 608, and/or environment). In some embodiments, the mount 620 is physically separate from the robot 604 and/or fixed to a ground location.

In some embodiments, a zone controller 632 (e.g., a PLC) is in communication with the cabinet 616. The zone controller 632 can process location information in a manner similar to that described above (e.g., it can receive more detailed location information (e.g., distances to a sensor) that is generalized and output as being only within or outside of a given safety zone). In some embodiments, one or more connection(s) 636 to the cabinet 616 can include a modern field bus communication, e.g., Profinet, EtherCAT or logic I/O. In some embodiments, the connection(s) 636 to the cabinet 616 can include direct control of the motor drive 612. In some embodiments, a switch 640 can be in communication with the zone controller 632 (e.g., to toggle between automatic and manual operation modes).

In some embodiments, an encoder 644 is attached to the conveyor 608 (or another location fixed relative to the conveyor 608). The encoder 644 can be configured to sense location information of the conveyor 608 (e.g., an absolute position of the conveyor and/or an amount of extension of the conveyor 608). In some embodiments, the location information corresponds to an end of the conveyor 608. In some embodiments, the location information corresponds to an end of a section of the conveyor 608 (from which the end of the conveyor 608 can be inferred within a given uncertainty). In some embodiments, the encoder 644 can sense location information in a way that is reliable for safety-related calculations to be performed and/or is redundant with location information received from other sources. In some embodiments, the encoder 644 is connected to the zone controller 632 (e.g., via a modern field bus). In some embodiments, encoder data (e.g., LiDAR data) is shared between multiple zone controllers and/or multiple calculations by one master zone controller (e.g., in a case in which two adjacent bays have one LiDAR located between them).

In some embodiments, a structure 648 is attached to an end of the conveyor 608. The structure 648 can include one or more fiducials, which can be sensed by the robot 604 and/or can communicate information (e.g., a conveyor pose, a conveyor ID, and/or a zone ID) that can be used to determine a location of the robot 604. In some embodiments, the robot 604 can sense a fiducial to verify a zone identification before transitioning to a manipulation task (at which point a LiDAR device can begin monitoring a region near a ramp). In some embodiments, having a line-of-sight to a fiducial can help ensure that the robot 604 is in front of the conveyor 608. In some embodiments, LiDAR fields can help ensure that the robot 604 has not moved to another bay). The structure 648 can also include a means of preventing the robot 604 from moving past a side of the conveyor 608. In some embodiments, such means comprises a purely physical constraint (e.g., requiring a linear distance from either side of the structure 648 to the corresponding wall of the container to be less than a width of the robot 604). In some embodiments, such means is implemented virtually, e.g., using one or more sensors on the structure 648 in communication with one or more computing devices controlling motion of the conveyor 608. In some embodiments, the structure 648 includes a RFID tag or other unique electronic identifier.

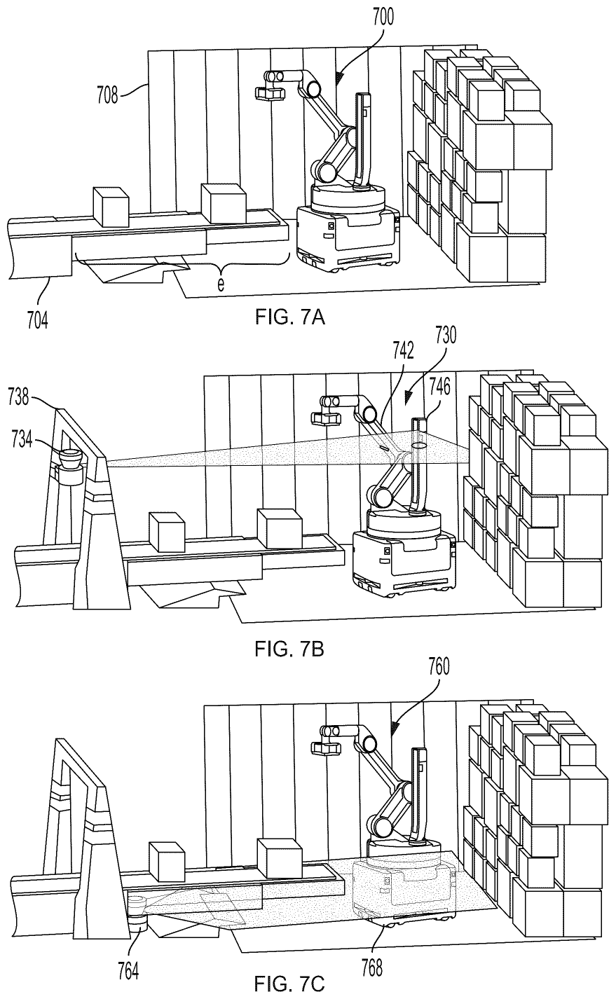

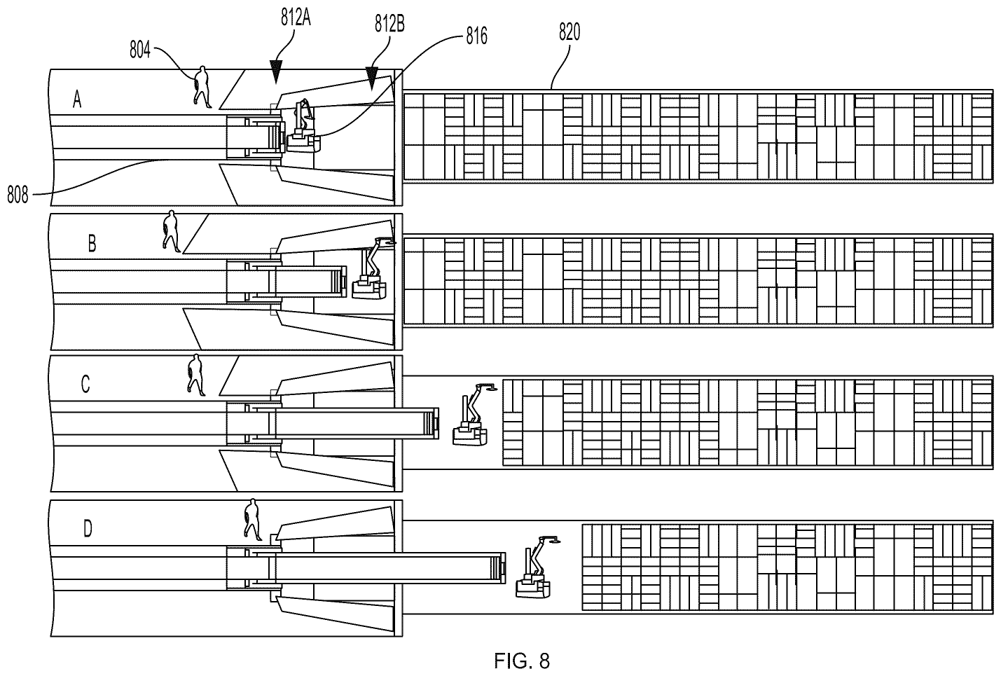

FIGS. 7A-7C illustrate different systems and methods of sensing a distance to a robot, according to an illustrative embodiment of the invention. FIG. 7A shows a configuration in which a robot 700 is “penned” past a conveyor 704 that is extended by a length e (e.g., constrained by a width of the container 708 in which robot 700 is located, such that a distance to a closest wall of the container 708 on either side of the conveyor 708 is less than a width of the robot 700). In this configuration, a position of the end of the conveyor 704 can be determined (e.g., using a laser range finder, a LiDAR sensor, and/or an encoder) and the robot 700 can be inferred to be at least a certain distance from objects outside of the container 708. FIG. 7B shows a configuration in which a location of the robot 730 is measured using a sensor 734 (e.g., a LiDAR or RADAR sensor) positioned on a mount 738 (e.g., a sensing arch) to sense a position of an arm 742 and/or a mast 746 of the robot 730. FIG. 7C shows a configuration in which a location of the robot 730 is measured using a sensor 764 (e.g., a LiDAR or RADAR sensor) to sense a position of a mobile base 768 of the robot 760. The configurations in FIGS. 7A-7C are illustrative only, and one having ordinary skill in the art will appreciate that other similar configurations are also possible.

FIG. 8 is a schematic illustration of different configurations (A-D) of a robot and an entity in the environment of the robot that can result in different operating parameters being determined for the robot, according to an illustrative embodiment of the invention. Reference characters are illustrated in configuration A and are not reproduced for configurations B-D to reduce visual clutter. In configuration A, an entity 804 (here a human) located on one side of a conveyor 808 is outside any illustrated safety zone 812A, 812B of the robot 816, the conveyor 808 is fully retracted, and the robot 816 is located outside of the container 820. As shown, the entity 804 is located close to the robot 816. In this configuration, the base speed limit may be set very low (e.g., 300 mm/s), and/or the manipulator arm may be required to be in a “stow” position. In configuration B, the conveyor 808 is partially extended, and the robot 816 remains located outside of the container 820. In this configuration, the base speed limit may be set low (e.g., 500 mm/s). In configuration C, the conveyor 808 is extended even further, and the robot 816 is located inside the container 820. In this configuration, the base and/or arm speed limits may be removed, provided that the illustrated safety zones 812A, 812B remain unoccupied. In configuration D, the conveyor 808 is extended even further into the container 820, and the robot 816 is also located further inside the container 820. In this configuration, the monitored safety zones have been reduced relative to the other configurations (e.g., zone 812 A is no longer depicted), and the robot 816 may operate at full speed, unless the nearer safety zone 812B is breached.

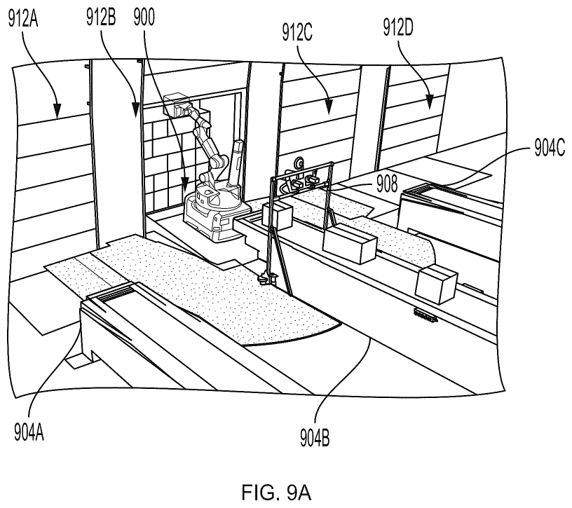

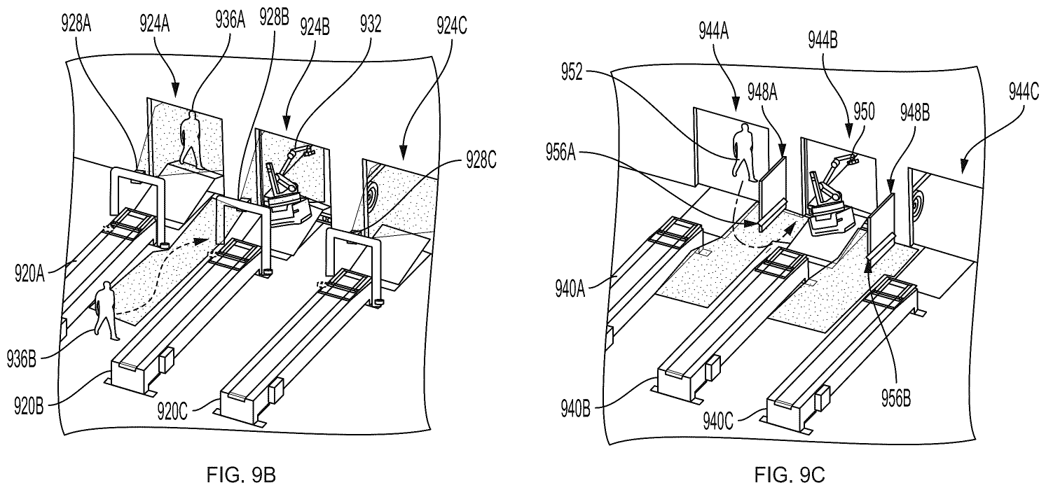

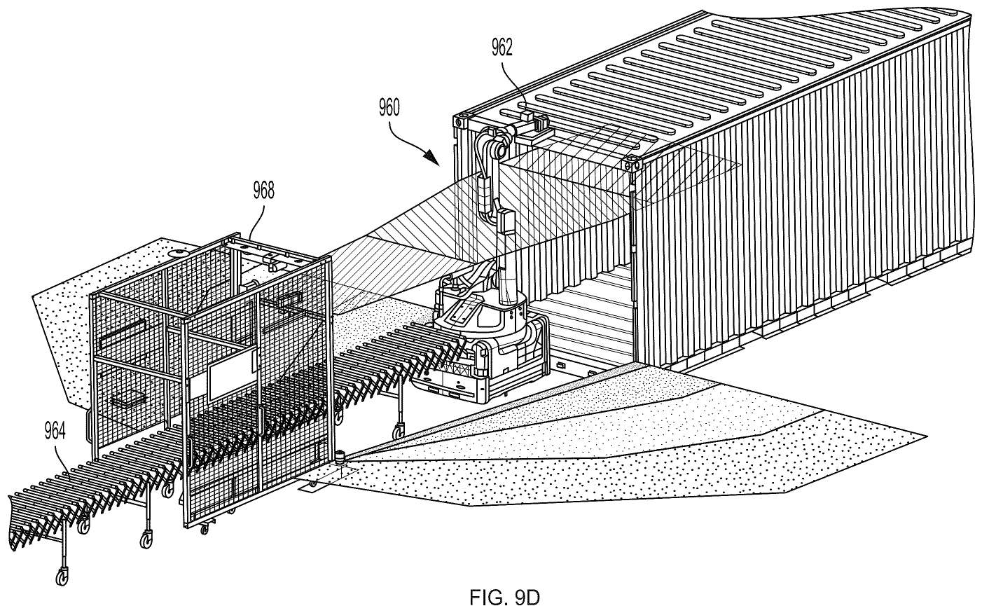

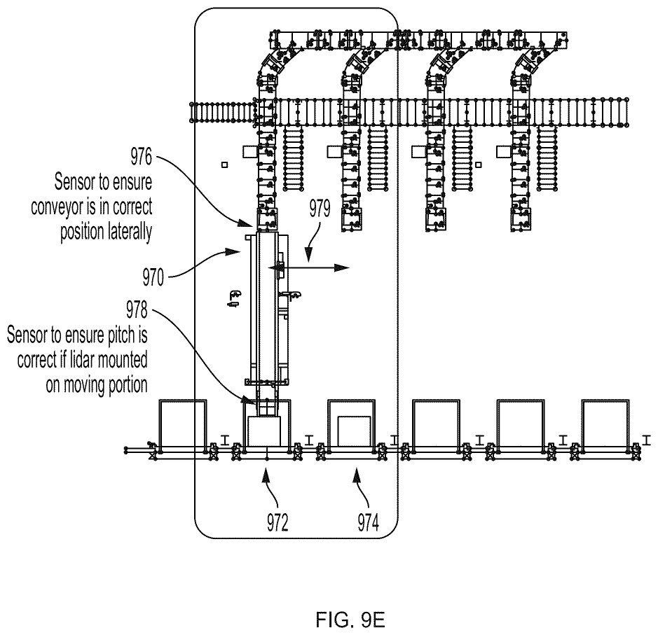

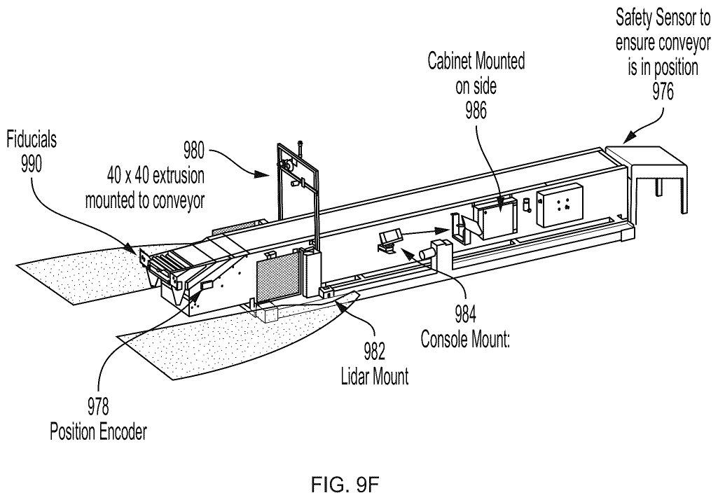

FIG. 9A is an illustration of a telescopic conveyor 904B having a mount 908 in an environment of a robot 900 located near a loading bay 912B of a warehouse, according to an illustrative embodiment of the invention. In this illustration, additional bays (e.g., 912A, 912C) of the warehouse are visible, which can have their own conveyors (e.g., 904A, 904C, respectively). In some embodiments, each conveyor 904 can have a mount 908 (other mounts not shown in FIG. 9A for simplicity). In some embodiments, the mount 908 can be portable between automated conveyors. In some embodiments, one or more automated conveyors can move between bays. In some embodiments, a field of view of at least one sensor can be adjusted based on, for example, a position of the conveyor, a location of the robot 900, a location of a bay in the environment of the robot 900, and/or a position of one or more entities in the environment of the robot 900. In some embodiments, other variables can affect the location information for the one or more entities and/or the robot 900 (e.g., a presence or absence of entities in a bay in the environment of the robot 900, and/or a state of a door of the bay as open or shut).

In FIG. 9A, a position of the robot 900 can be determined (e.g., bounded) by an amount of extension of the conveyor 904B in conjunction with sufficient assurances that the robot 900 is located on the far side of the conveyor 904B (e.g., as described above). In some embodiments, an extension length of the conveyor 904B can be determined using a suitable sensor (e.g., at least one of a rotational encoder, a linear encoder, a laser range finder, a LiDAR sensor, a proximity sensor, or a discrete sensor that indicates a specific position of the conveyor 904B, such as a set of electrical switches that are pressed once the conveyor extends past a certain point). In some embodiments, one or more suitable sensors (e.g., LiDAR and/or RADAR) can be used to sense encroachment by people or other entities in the environment. In some embodiments, separation distances can be calculated by a zone controller (e.g., as described above), and operating parameters (e.g., speed limits and/or stopping times) can be sent (e.g., via wireless black channel communication) to the robot 900.

FIG. 9B is an illustration of multiple telescopic conveyors 920A-C servicing multiple bays 924A-C, with each bay monitored by respective sensors 928A-C, according to an illustrative embodiment of the invention. In some embodiments, the sensors 928A-C include RADAR sensors pointed toward the bays 924A-C and/or LiDAR sensors to monitor entities of concern in the environment, as described above, although a variety of sensors may be used. In some embodiments, the robot 932 in the bay 924B can assume that no entities of concern are occupying neighboring bays 924A, 924C if safety zones corresponding to the bays 924A, 924C are enabled. In some embodiments, the robot 932 can assume that no entities of concern are occupying neighboring bays 924A, 924C if no motion is detected by the corresponding sensors 928A, 928C. However, in the example scenario shown in FIG. 9B, the entity 936A is occupying the bay 924A, and motion of entity 936A is detected by the sensor(s) 924A. FIG. 9B also shows that entity 936B is being detected by LiDAR (e.g., at or near the sensor 928B).

In some embodiments, the sensor(s) 928B measures the position of the robot 932B (e.g., within a container corresponding to the bay 924B) without any modifications made to the conveyor 920B. In some embodiments, RADAR sensors can sense motion inside neighboring bays 928A, 928C. In some embodiments, a large number of bays can be used under the same basic scheme. In some embodiments, the RADAR sensor acts as an additional check before start of operation of the robot (e.g., to confirm that no entities of concern are in any safety zone relevant to the robot under consideration). In some embodiments, the FIG. 9B configuration can help to prevent entities of concern from appearing suddenly very close to the robot 924B.

FIG. 9C is an illustration of multiple telescopic conveyors 940A-C servicing multiple bays 944A-C, with physical guards 948A, 948B protecting one or more bays, according to an illustrative embodiment of the invention. In some embodiments, the physical guards 948A-B are cage panels protruding from the loading dock wall. Such panels can effectively increase the path length of an entity of concern 952 through the observable area associated with the bay 940B of the robot 950, making it more likely that such entity 952 will be detected by one or more sensors (and thus that such entity will not suddenly appear leaving little time for the robot to react). In some embodiments, the physical guards 948A-B include one or more openings or slits 956A-B that enable the sensor(s) to “look through” the slit(s) to sense the presence of entities of concern behind the physical guards 948A-B.

FIG. 9D is an illustration of a robot 960 unloading a container 962 onto an accordion conveyor 964, according to an illustrative embodiment of the invention. In FIG. 9D, the robot 960 is sensed in a manner similar to that shown and described in connection with FIG. 7B. One notable difference is that in FIG. 9D, an accordion conveyor is used rather than the telescopic conveyor used in the scenario of FIG. 7B. Also shown in FIG. 9D is a cage 968 which contains one or more structures to which sensors are mounted (e.g., in place of the sensing arch 738 shown above in FIG. 7B).

FIG. 9E is a top down illustration of a telescopic conveyor 970 configured to service multiple bays, according to an illustrative embodiment of the invention. For instance telescopic conveyor 970 may include a drive system configured to move the conveyor laterally (e.g., along the ground or on rails) between bay 972 and bay 974, as indicated by arrow 979. When positioned within a bay, a working end of the conveyor 970 (e.g., where objects are loaded on the conveyor) may be arranged near a truck or other container in the bay from which a robot may move objects from the container onto the conveyor. As shown in FIG. 9E, the other end of the conveyor 970 may be positioned proximate to a downstream conveyor system that receives objects from the conveyor 970. In some embodiments, one or more sensors are added to the ends of the conveyor 970 to facilitate alignment of the conveyor 970 and/or to define safety fields around the conveyor. For instance, a sensor 976 may be coupled to a portion of conveyor 970 (e.g., coupled to a zone controller associated with the conveyor) to detect and/or confirm alignment of the conveyor 970 with a downstream conveyor system. As shown in FIG. 9E, a sensor 978 may be coupled to the working end of conveyor 970. In some embodiments, sensor 978 is a position encoder sensor. When mounted on a pitchable component of conveyor 370, information from sensor 978 may be used to ensure that the pitch of the working end of the conveyor is adjusted properly for the particular dock geometry of the bay in which it is located. In some embodiments, information sensed by sensor 978 may additionally be used to identify the bay at which the conveyor 970 is currently located. Some bays may have different dock geometry configurations, and as such, identifying the bay at which the conveyor 970 is currently located may be used, for example, to define an appropriate safety perimeter for the conveyor 970. For instance, each bay in a warehouse may be associated with stored safety perimeter information, and one or more safety zones surrounding the conveyor 970 may be defined based, at least in part, based on identification of the bay at which the conveyor is currently located.

FIG. 9F shows a perspective view of telescopic conveyor 970, according to an illustrative embodiment of the invention. As shown in FIG. 9F, telescopic conveyor 970 includes sensor 976 configured to facilitate alignment of the conveyor with a downstream conveyor system and sensor 978 configured to ensure that the pitch of the working end of the conveyor is adjusted properly prior to operation with a particular bay at which it is located, as described above in connection with FIG. 9E. Because conveyor 970 is configured to move laterally between different bays, all sensing components of the conveyor may be coupled to the conveyor so they can move along with the conveyor rather than be fixed in the warehouse environment. For instance, conveyor 370 includes mount 980 (here a sensing arch, although other structures are possible) mounted to the conveyor rather than being floor mounted, as described in the example conveyor arrangement of FIG. 9B. Similar to the mount described in connection with the example of FIG. 9B, mount 980 may include one or more sensors for determining location information for the one or more entities and/or location information for a robot operating in proximity to conveyor 970. In some embodiments, the sensors can include one or more cameras, LIDAR sensors, RADAR sensors, RF sensors, laser range finding sensors, Bluetooth sensors, RFID tags, and/or location tracking tags. In some embodiments, the mount 980 holds one or more lights (e.g., to indicate to a human when a safety zone is violated, when a robot is slowing, and/or on which side of the conveyor 970 there has been a breach of the safety zone).

Also coupled to conveyor 970 are components similar to those described in connection with other embodiments including console mount 984, cabinet 986 and fiducials 990 arranged on the working end of the conveyer to facilitate positioning of the conveyor in a bay (e.g., relative to a robot working in the bay). Conveyor 970 also includes LIDAR sensor 982 arranged to sense objects (e.g., humans) within one or more safety zones surrounding to the conveyor 370 as described herein. In some embodiments, sensor 978 or another sensor (e.g., a LIDAR sensor) may be coupled to a portion of the conveyor having adjustable pitch to facilitate sensing of objects within the safety zone(s). For instance, by coupling a sensor to a pitchable portion of the conveyor 370, the sensor can be oriented in a plurality of configurable positions to facilitate observation of objects within an appropriate safety field surrounding the conveyor.

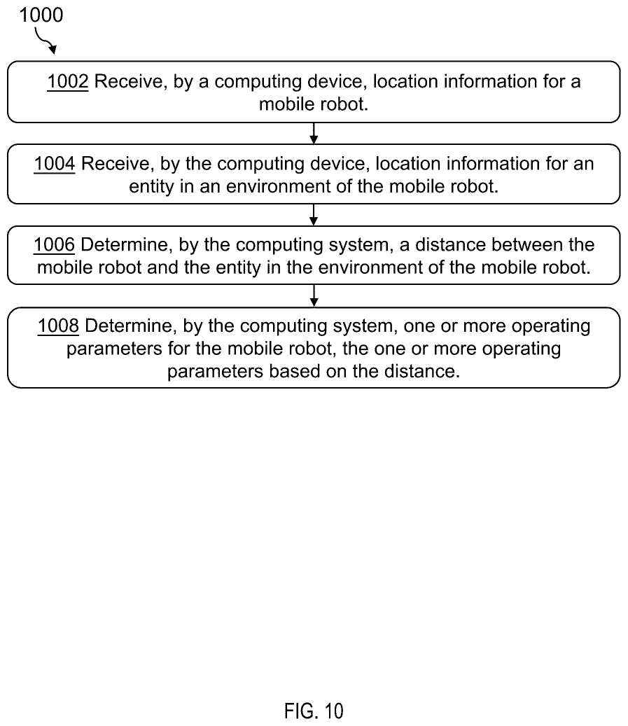

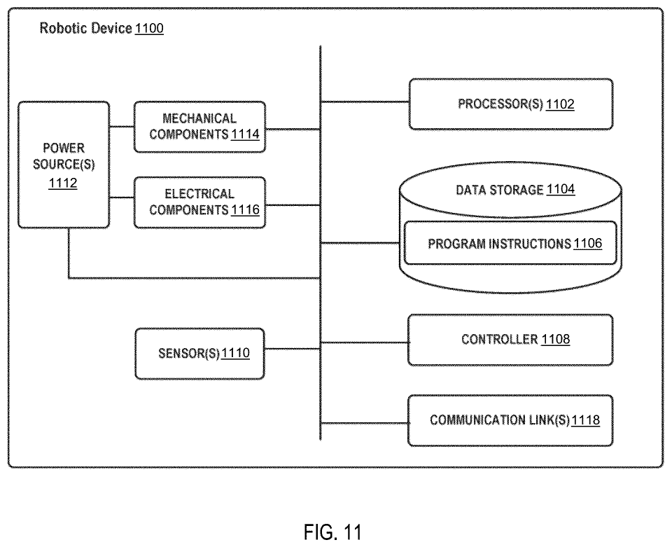

FIG. 10 is a flow diagram of a method 1000 according to an illustrative embodiment of the invention. At step 1002, a computing device receives location information for a mobile robot. At step 1004, the computing device receives location information for an entity in an environment of the mobile robot. At step 1006, the computing device determines a distance between the mobile robot and the entity in the environment of the mobile robot. At step 1008, the computing device determines one or more operating parameters for the mobile robot, the one or more operating parameters based on the distance.

FIG. 11 illustrates an example configuration of a robotic device 1100, according to an illustrative embodiment of the invention. An example implementation involves a robotic device configured with at least one robotic limb, one or more sensors, and a processing system. The robotic limb may be an articulated robotic appendage including a number of members connected by joints. The robotic limb may also include a number of actuators (e.g., 2-5 actuators) coupled to the members of the limb that facilitate movement of the robotic limb through a range of motion limited by the joints connecting the members. The sensors may be configured to measure properties of the robotic device, such as angles of the joints, pressures within the actuators, joint torques, and/or positions, velocities, and/or accelerations of members of the robotic limb(s) at a given point in time. The sensors may also be configured to measure an orientation (e.g., a body orientation measurement) of the body of the robotic device (which may also be referred to herein as the “base” of the robotic device). Other example properties include the masses of various components of the robotic device, among other properties. The processing system of the robotic device may determine the angles of the joints of the robotic limb, either directly from angle sensor information or indirectly from other sensor information from which the joint angles can be calculated. The processing system may then estimate an orientation of the robotic device based on the sensed orientation of the base of the robotic device and the joint angles.

An orientation may herein refer to an angular position of an object. In some instances, an orientation may refer to an amount of rotation (e.g., in degrees or radians) about three axes. In some cases, an orientation of a robotic device may refer to the orientation of the robotic device with respect to a particular reference frame, such as the ground or a surface on which it stands. An orientation may describe the angular position using Euler angles, Tait-Bryan angles (also known as yaw, pitch, and roll angles), and/or Quaternions. In some instances, such as on a computer-readable medium, the orientation may be represented by an orientation matrix and/or an orientation quaternion, among other representations.

In some scenarios, measurements from sensors on the base of the robotic device may indicate that the robotic device is oriented in such a way and/or has a linear and/or angular velocity that requires control of one or more of the articulated appendages in order to maintain balance of the robotic device. In these scenarios, however, it may be the case that the limbs of the robotic device are oriented and/or moving such that balance control is not required. For example, the body of the robotic device may be tilted to the left, and sensors measuring the body's orientation may thus indicate a need to move limbs to balance the robotic device; however, one or more limbs of the robotic device may be extended to the right, causing the robotic device to be balanced despite the sensors on the base of the robotic device indicating otherwise. The limbs of a robotic device may apply a torque on the body of the robotic device and may also affect the robotic device's center of mass. Thus, orientation and angular velocity measurements of one portion of the robotic device may be an inaccurate representation of the orientation and angular velocity of the combination of the robotic device's body and limbs (which may be referred to herein as the “aggregate” orientation and angular velocity).

In some implementations, the processing system may be configured to estimate the aggregate orientation and/or angular velocity of the entire robotic device based on the sensed orientation of the base of the robotic device and the measured joint angles. The processing system has stored thereon a relationship between the joint angles of the robotic device and the extent to which the joint angles of the robotic device affect the orientation and/or angular velocity of the base of the robotic device. The relationship between the joint angles of the robotic device and the motion of the base of the robotic device may be determined based on the kinematics and mass properties of the limbs of the robotic devices. In other words, the relationship may specify the effects that the joint angles have on the aggregate orientation and/or angular velocity of the robotic device. Additionally, the processing system may be configured to determine components of the orientation and/or angular velocity of the robotic device caused by internal motion and components of the orientation and/or angular velocity of the robotic device caused by external motion. Further, the processing system may differentiate components of the aggregate orientation in order to determine the robotic device's aggregate yaw rate, pitch rate, and roll rate (which may be collectively referred to as the “aggregate angular velocity”).

In some implementations, the robotic device may also include a control system that is configured to control the robotic device on the basis of a simplified model of the robotic device. The control system may be configured to receive the estimated aggregate orientation and/or angular velocity of the robotic device, and subsequently control one or more jointed limbs of the robotic device to behave in a certain manner (e.g., maintain the balance of the robotic device).

In some implementations, the robotic device may include force sensors that measure or estimate the external forces (e.g., the force applied by a limb of the robotic device against the ground) along with kinematic sensors to measure the orientation of the limbs of the robotic device. The processing system may be configured to determine the robotic device's angular momentum based on information measured by the sensors. The control system may be configured with a feedback-based state observer that receives the measured angular momentum and the aggregate angular velocity, and provides a reduced-noise estimate of the angular momentum of the robotic device. The state observer may also receive measurements and/or estimates of torques or forces acting on the robotic device and use them, among other information, as a basis to determine the reduced-noise estimate of the angular momentum of the robotic device.

In some implementations, multiple relationships between the joint angles and their effect on the orientation and/or angular velocity of the base of the robotic device may be stored on the processing system. The processing system may select a particular relationship with which to determine the aggregate orientation and/or angular velocity based on the joint angles. For example, one relationship may be associated with a particular joint being between 0 and 90 degrees, and another relationship may be associated with the particular joint being between 91 and 180 degrees. The selected relationship may more accurately estimate the aggregate orientation of the robotic device than the other relationships.

In some implementations, the processing system may have stored thereon more than one relationship between the joint angles of the robotic device and the extent to which the joint angles of the robotic device affect the orientation and/or angular velocity of the base of the robotic device. Each relationship may correspond to one or more ranges of joint angle values (e.g., operating ranges). In some implementations, the robotic device may operate in one or more modes. A mode of operation may correspond to one or more of the joint angles being within a corresponding set of operating ranges. In these implementations, each mode of operation may correspond to a certain relationship.

The angular velocity of the robotic device may have multiple components describing the robotic device's orientation (e.g., rotational angles) along multiple planes. From the perspective of the robotic device, a rotational angle of the robotic device turned to the left or the right may be referred to herein as “yaw.” A rotational angle of the robotic device upwards or downwards may be referred to herein as “pitch.” A rotational angle of the robotic device tilted to the left or the right may be referred to herein as “roll.” Additionally, the rate of change of the yaw, pitch, and roll may be referred to herein as the “yaw rate,” the “pitch rate,” and the “roll rate,” respectively.

Referring now to the figures, FIG. 11 illustrates an example configuration of a robotic device (or “robot”) 1100, according to an illustrative embodiment of the invention. The robotic device 1100 represents an example robotic device configured to perform the operations described herein. Additionally, the robotic device 1100 may be configured to operate autonomously, semi-autonomously, and/or using directions provided by user(s), and may exist in various forms, such as a humanoid robot, biped, quadruped, or other mobile robot, among other examples. Furthermore, the robotic device 1100 may also be referred to as a robotic system, mobile robot, or robot, among other designations.

As shown in FIG. 11, the robotic device 1100 includes processor(s) 1102, data storage 1104, program instructions 1106, controller 1108, sensor(s) 1110, power source(s) 1112, mechanical components 1114, and electrical components 1116. The robotic device 1100 is shown for illustration purposes and may include more or fewer components without departing from the scope of the disclosure herein. The various components of robotic device 1100 may be connected in any manner, including via electronic communication means, e.g., wired or wireless connections. Further, in some examples, components of the robotic device 1100 may be positioned on multiple distinct physical entities rather on a single physical entity. Other example illustrations of robotic device 1100 may exist as well.

Processor(s) 1102 may operate as one or more general-purpose processor or special purpose processors (e.g., digital signal processors, application specific integrated circuits, etc.). The processor(s) 1102 can be configured to execute computer-readable program instructions 1106 that are stored in the data storage 1104 and are executable to provide the operations of the robotic device 1100 described herein. For instance, the program instructions 1106 may be executable to provide operations of controller 1108, where the controller 1108 may be configured to cause activation and/or deactivation of the mechanical components 1114 and the electrical components 1116. The processor(s) 1102 may operate and enable the robotic device 1100 to perform various functions, including the functions described herein.

The data storage 1104 may exist as various types of storage media, such as a memory. For example, the data storage 1104 may include or take the form of one or more computer-readable storage media that can be read or accessed by processor(s) 1102. The one or more computer-readable storage media can include volatile and/or non-volatile storage components, such as optical, magnetic, organic or other memory or disc storage, which can be integrated in whole or in part with processor(s) 1102. In some implementations, the data storage 1104 can be implemented using a single physical device (e.g., one optical, magnetic, organic or other memory or disc storage unit), while in other implementations, the data storage 1104 can be implemented using two or more physical devices, which may communicate electronically (e.g., via wired or wireless communication). Further, in addition to the computer-readable program instructions 1106, the data storage 1104 may include additional data such as diagnostic data, among other possibilities.

The robotic device 1100 may include at least one controller 1108, which may interface with the robotic device 1100. The controller 1108 may serve as a link between portions of the robotic device 1100, such as a link between mechanical components 1114 and/or electrical components 1116. In some instances, the controller 1108 may serve as an interface between the robotic device 1100 and another computing device. Furthermore, the controller 1108 may serve as an interface between the robotic system 1100 and a user(s). The controller 1108 may include various components for communicating with the robotic device 1100, including one or more joysticks or buttons, among other features. The controller 1108 may perform other operations for the robotic device 1100 as well. Other examples of controllers may exist as well.

Additionally, the robotic device 1100 includes one or more sensor(s) 1110 such as force sensors, proximity sensors, motion sensors, load sensors, position sensors, touch sensors, depth sensors, ultrasonic range sensors, and/or infrared sensors, among other possibilities. The sensor(s) 1110 may provide sensor data to the processor(s) 1102 to allow for appropriate interaction of the robotic system 1100 with the environment as well as monitoring of operation of the systems of the robotic device 1100. The sensor data may be used in evaluation of various factors for activation and deactivation of mechanical components 1114 and electrical components 1116 by controller 1108 and/or a computing system of the robotic device 1100.

The sensor(s) 1110 may provide information indicative of the environment of the robotic device for the controller 1108 and/or computing system to use to determine operations for the robotic device 1100. For example, the sensor(s) 1110 may capture data corresponding to the terrain of the environment or location of nearby objects, which may assist with environment recognition and navigation, etc. In an example configuration, the robotic device 1100 may include a sensor system that may include a camera, RADAR, LIDAR, time-of-flight camera, global positioning system (GPS) transceiver, and/or other sensors for capturing information of the environment of the robotic device 1100. The sensor(s) 1110 may monitor the environment in real-time and detect obstacles, elements of the terrain, weather conditions, temperature, and/or other parameters of the environment for the robotic device 1100.

Further, the robotic device 1100 may include other sensor(s) 1110 configured to receive information indicative of the state of the robotic device 1100, including sensor(s) 1110 that may monitor the state of the various components of the robotic device 1100. The sensor(s) 1110 may measure activity of systems of the robotic device 1100 and receive information based on the operation of the various features of the robotic device 1100, such the operation of extendable legs, arms, or other mechanical and/or electrical features of the robotic device 1100. The sensor data provided by the sensors may enable the computing system of the robotic device 1100 to determine errors in operation as well as monitor overall functioning of components of the robotic device 1100.

For example, the computing system may use sensor data to determine the stability of the robotic device 1100 during operations as well as measurements related to power levels, communication activities, components that require repair, among other information. As an example configuration, the robotic device 1100 may include gyroscope(s), accelerometer(s), and/or other possible sensors to provide sensor data relating to the state of operation of the robotic device. Further, sensor(s) 1110 may also monitor the current state of a function that the robotic system 1100 may currently be operating. Additionally, the sensor(s) 1110 may measure a distance between a given robotic limb of a robotic device and a center of mass of the robotic device. Other example uses for the sensor(s) 1110 may exist as well.

Additionally, the robotic device 1100 may also include one or more power source(s) 1112 configured to supply power to various components of the robotic device 1100. Among possible power systems, the robotic device 1100 may include a hydraulic system, electrical system, batteries, and/or other types of power systems. As an example illustration, the robotic device 1100 may include one or more batteries configured to provide power to components via a wired and/or wireless connection. Within examples, components of the mechanical components 1114 and electrical components 1116 may each connect to a different power source or may be powered by the same power source. Components of the robotic system 1100 may connect to multiple power sources as well.

Within example configurations, any type of power source may be used to power the robotic device 1100, such as a gasoline and/or electric engine. Further, the power source(s) 1112 may charge using various types of charging, such as wired connections to an outside power source, wireless charging, combustion, or other examples. Other configurations may also be possible. Additionally, the robotic device 1100 may include a hydraulic system configured to provide power to the mechanical components 1114 using fluid power. Components of the robotic device 1100 may operate based on hydraulic fluid being transmitted throughout the hydraulic system to various hydraulic motors and hydraulic cylinders, for example. The hydraulic system of the robotic device 1100 may transfer a large amount of power through small tubes, flexible hoses, or other links between components of the robotic device 1100. Other power sources may be included within the robotic device 1100.

Mechanical components 1114 can represent hardware of the robotic system 1100 that may enable the robotic device 1100 to operate and perform physical functions. As a few examples, the robotic device 1100 may include actuator(s), extendable leg(s), arm(s), wheel(s), one or multiple structured bodies for housing the computing system or other components, and/or other mechanical components. The mechanical components 1114 may depend on the design of the robotic device 1100 and may also be based on the functions and/or tasks the robotic device 1100 may be configured to perform. As such, depending on the operation and functions of the robotic device 1100, different mechanical components 1114 may be available for the robotic device 1100 to utilize. In some examples, the robotic device 1100 may be configured to add and/or remove mechanical components 1114, which may involve assistance from a user and/or other robotic device.

The electrical components 1116 may include various components capable of processing, transferring, providing electrical charge or electric signals, for example. Among possible examples, the electrical components 1116 may include electrical wires, circuitry, and/or wireless communication transmitters and receivers to enable operations of the robotic device 1100. The electrical components 1116 may interwork with the mechanical components 1114 to enable the robotic device 1100 to perform various operations. The electrical components 1116 may be configured to provide power from the power source(s) 1112 to the various mechanical components 1114, for example. Further, the robotic device 1100 may include electric motors. Other examples of electrical components 1116 may exist as well.

In some implementations, the robotic device 1100 may also include communication link(s) 1118 configured to send and/or receive information. The communication link(s) 1118 may transmit data indicating the state of the various components of the robotic device 1100. For example, information read in by sensor(s) 1110 may be transmitted via the communication link(s) 1118 to a separate device. Other diagnostic information indicating the integrity or health of the power source(s) 1112, mechanical components 1114, electrical components 1118, processor(s) 1102, data storage 1104, and/or controller 1108 may be transmitted via the communication link(s) 1118 to an external communication device.

In some implementations, the robotic device 1100 may receive information at the communication link(s) 1118 that is processed by the processor(s) 1102. The received information may indicate data that is accessible by the processor(s) 1102 during execution of the program instructions 1106, for example. Further, the received information may change aspects of the controller 1108 that may affect the behavior of the mechanical components 1114 or the electrical components 1116. In some cases, the received information indicates a query requesting a particular piece of information (e.g., the operational state of one or more of the components of the robotic device 1100), and the processor(s) 1102 may subsequently transmit that particular piece of information back out the communication link(s) 1118.

In some cases, the communication link(s) 1118 include a wired connection. The robotic device 1100 may include one or more ports to interface the communication link(s) 1118 to an external device. The communication link(s) 1118 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

A number of implementations have been described. Nevertheless, it will be understood that various modifications may be made without departing from the spirit and scope of the disclosure.

What is claimed is:

1. A method comprising:
receiving, by a computing device, first location information for a mobile robot;
receiving, by the computing device, second location information for a first entity in an environment of the mobile robot;
determining, by the computing device, based, at least in part, on the first location information and the second location information, a first distance between the mobile robot and the first entity in the environment of the mobile robot; and
determining, by the computing device, one or more operating parameters for the mobile robot, the one or more operating parameters based on the first distance.

2. The method of claim 1, wherein receiving first location information for the mobile robot comprises receiving sensor data indicating a location of the mobile robot.

3. The method of claim 1, wherein receiving second location information for the first entity comprises receiving an indication that the first entity is located in a region defining a safety zone of the mobile robot.

4-6. (canceled)

7. The method of claim 1, further comprising controlling, by the computing device, the mobile robot to move according to the one or more operating parameters.

8. The method of claim 1, wherein the one or more operating parameters comprise one or more of an operating speed limit, a stopping time limit, or an operating acceleration limit.

9-14. (canceled)

15. The method of claim 1, further comprising receiving, by the computing device, a velocity of the first entity, wherein the one or more operating parameters are based on the velocity of the first entity.

16. The method of claim 1, further comprising receiving, by the computing device, an acceleration of the first entity, wherein the one or more operating parameters are based on the acceleration of the first entity.

17. (canceled)

18. The method of claim 1, further comprising:
receiving, by the computing device, third location information for a second entity in the environment of the mobile robot; and
determining, by the computing device, based on the third location information, a second distance between the mobile robot and the second entity,
wherein the one or more operating parameters are based on a smaller distance of the first distance and the second distance.

19. The method of claim 1, further comprising:
receiving, by the computing device, third location information for a second entity in the environment of the mobile robot; and
determining, based on the second location information and the third location information, which of the first entity and the second entity is closer to the mobile robot,
wherein the one or more operating parameters are based only on the first distance when it is determined that the first entity is closer to the mobile robot than the second entity.

20. The method of claim 1, wherein the environment of the mobile robot includes a plurality of entities, and wherein an entity of the plurality of entities located closest to the mobile robot is selected as the first entity.

21. The method of claim 1, wherein the first location information for the mobile robot and/or the second location information for the first entity are based on data received from one or more sensors in communication with the computing device.

22-23. (canceled)

24. The method of claim 21, wherein the one or more sensors are attached to a sensor mount physically separate from the mobile robot.

25-29. (canceled)

30. The method of claim 24, wherein the sensor mount is attached to a conveyor or a ground location in the environment of the mobile robot.

31-35. (canceled)

36. The method of claim 30, further comprising adjusting a sensing field of the one or more sensors based on at least one of (i) a position of the conveyor, (ii) a location of the mobile robot, (iii) a location of a bay in the environment of the mobile robot, or (iv) a position of the first entity.

37. The method of claim 30, further comprising controlling, by the computing device, the one or more sensors to sense a region located above an end of the conveyor.

38. The method of claim 1, further comprising controlling, by the computing device, the mobile robot to perform an emergency stop when the first distance is below a threshold distance and/or when the second location information for the first entity indicates that the first entity is located in a specified safety zone.

39. (canceled)

40. The method of claim 1, further comprising enforcing, by the mobile robot, the one or more operating parameters based on a motion plan of the mobile robot.

41. (canceled)

42. The method of claim 1, wherein the second location information for the first entity is based on a presence or absence of the first entity in a safety zone in the environment of the mobile robot.

43-45. (canceled)

46. The method of claim 1, further comprising commanding, by the computing device, a robotic arm of the mobile robot to assume a stowed position when the first entity is determined to be less than a threshold distance from the mobile robot.

47-52. (canceled)

53. A computing system of a mobile robot, the computing system comprising:
data processing hardware; and
memory hardware in communication with the data processing hardware, the memory hardware storing instructions that when executed on the data processing hardware cause the data processing hardware to perform operations comprising:
receiving first location information for the mobile robot;
receiving second location information for a first entity in an environment of the mobile robot;
determining based, at least in part, on the first location information and the second location information, a first distance between the mobile robot and the first entity in the environment of the mobile robot; and
determining one or more operating parameters for the mobile robot, the one or more operating parameters based on the first distance.

54-111. (canceled)
